(19) United States
(12) Patent Application Publication
(10) Pub. No.: US 2016/0232304 A1
(43) Pub. Date: Aug. 11, 2016

(54) SYSTEMS AND METHODS FOR OBTAINING AND DISPLAYING MEDICAL DATA TO ASSIST DECISION MAKING DURING A MEDICAL EMERGENCY

(71) Applicant: Mayank GOYAL, Calgary (CA)

(72) Inventor: Mayank GOYAL, Calgary (CA)

(21) Appl. No.: 15/023,089

(22) PCT Filed: Sep. 18, 2014
(86) PCT No.: PCT/CA2014/050899

§ 371 Date: Mar. 18, 2016

Related U.S. Application Data
(60) Provisional application No. 61/880,072, filed on Sep. 19, 2013.

(51) Int. Cl. G06F 19/00

(52) U.S. Cl. CPC G06F 19/322

(57) ABSTRACT

The invention relates to systems and methods for obtaining particular medical data from a patient and organizing and presenting medical data for the objective of improving workflow and decision making during a medical emergency. More specifically, the systems and methods enable a first party to enter specific medical information about the patient wherein the system organizes the medical data in terms of relevancy for potential emergency situations and displays that relevant medical information to another party when that another party gains access to the system when a medical emergency is occurring.

### FIELD OF THE INVENTION

The invention relates to systems and methods for obtaining particular medical data from a patient and organizing and presenting medical data for the objective of improving workflow and decision making during a medical emergency.

### BACKGROUND OF THE INVENTION

In the administration and delivery of health care, there are numerous occasions and circumstances where administrative and legal issues are in conflict with the optimal process for the delivery of a particular procedure.

As is well known, certain medical events such as a stroke or a heart attack (myocardial infarction) are true emergencies where every minute between onset and treatment can have a significant affect on the outcome of the patient. Similarly, the outcome from trauma medical emergencies such as motor vehicle accidents, drownings, falls and natural or accidental catastrophes can also be significantly affected by time delays between occurrence and treatment.

Urgent treatments of these conditions are based on a number of well established inclusions/exclusions related to past history, ongoing medications, results of blood and other tests, and patient's and their family's wishes.

While patients may have a complex past history with a number of complex procedures having been performed in the past, very few things are relevant for decision making when an emergency is presenting itself. For example, a patient may have had a hip fracture and a gall bladder removal in the distant past which would be included in the patient's records but for the most part will not be relevant for acute decision making. Similarly the patient may be on analgesics for joint pain which for the most part will not influence the decision making for treating acute stroke or heart attack. On the other hand the patient may be on blood thinners like Coumadin which would have a dramatic influence on whether the patient can be treated with thrombolytics if they are having an acute stroke.

As a result, there is need for systems that provide relevant past medical history, drug history and other medical data in a concise fashion based on its relevance to the treatment of the emergency condition.

In today's advanced medical treatment facilities, legal issues are important considerations that affect how medical procedures are delivered. Legal issues include practitioner/facility liability, patient consent, patient privacy and other considerations that may be relevant to a particular situation. Importantly, the legal system both from a legislation and case law perspective has caused the development of “best practices” that medical practitioners and facilities follow to ensure compliance with appropriate legislation as well as to minimize liability risks to the facility and practitioner.

As is known, prior to a physician performing a medical procedure on a patient, the physician is obligated to obtain the consent of the patient. Obtaining consent is a variable and often complex procedure that will depend on the medical circumstances and/or the complexity of the procedure that is to be undertaken, the jurisdiction as well as over-riding legislation. In particularly urgent situations, the circumstances may warrant that an attending physician does not obtain specific consent from the patient where, in the physician's best judgment, the patient cannot provide such consent and would otherwise die or have a poor outcome if specific consent was obtained. In other words, the act of obtaining consent can often affect the outcome of treatment as it can lead to significant delays.

At the other end of the spectrum, elective and medically un-necessary surgery may require one or more patient/surgeon consultations and detailed legal documents to be signed and witnessed prior to a procedure to be undertaken. Between these two extremes, varying levels of consent may be required depending on the circumstances.

Consent/decision making also involves access to medical records. That is, the process of giving consent usually also provides authorization to access the medical records of the patient. Unfortunately, organization and access to medical records is a difficult and often inefficient process as an individual's records may be widely distributed from a geographical perspective, be comprised of both paper and electronic components, and be substantively inaccessible in a timely manner.

The nature of the acute condition itself, most commonly acute stroke and head injury also affects the ability of people to give consent or be fully informed of their pre-existent conditions and medications. Further, the consent issue can also be complicated when minors are involved or those with limited intellectual decision making capabilities where legal guardians or individuals having power of attorney must become involved.

Further still, with regards to older people and a generally aging population, the consent issue can be complicated by issues specific to this population.

Notably, there are an increasing number of people affected by varying degrees of dementia who interact with the medical system. As dementia ranges in severity and will progress at different rates in different people, the time at which a dementia patient loses their ability to provide informed consent is uncertain which can cause delays when the patient may require a possible treatment.

In addition, older people are more mobile and travel further from home than ever before. As a result, there is an increasing amount of medical treatment being provided to older patients away from their home jurisdictions. In addition to the general concern of requiring medical care whilst travelling, access to their medical records whilst travelling is also of significant concern to many older travelers. This concern is not of course limited to older travelers as it also demonstrates a general need for all patients to have access to their medical records wherever they are.

In addition to the basic consent issue, there are issues regarding where medical records are being kept.

For the medical practitioner, when any patient is encountered, there are a variety of questions that are immediately considered by the practitioner in order to make a series of decisions in respect of both diagnosis and to initiate (or not) medical treatment.

At the highest level, these questions generally include:
Is it absolutely clear what the diagnosis is?
Are there diagnostic tests that need to be performed urgently to help with the diagnosis?
Are there any contraindications to these diagnostic tests?
Are there results available from previously performed diagnostic tests that can obviate the need for re-doing the tests?
Are there treatment choices, which if provided in a timely fashion can alter the course of disease?
Are these treatment options considered standard of care?
Are there certain pre-requisites that need to be met to proceed further (e.g. renal function, absence of blood thinners, absence of pacemaker, living will etc.)?
Are there consent related issues that need to be met prior to decision making?
What are the patient's wishes (advance directives) regarding issues such as quality of life, life support, and organ transplant?

The decision making process will naturally be affected by a number of factors, including geography, age of the patient and time factors. In addition, the process will be affected by two broad categories of information including:
1. Information is sufficient to provide a clear answer.
2. Information provides no clear answer but there are a number of reasonable treatment options and/or courses of action.

With regards, to the medico-legal issues, in most jurisdictions there are significant privacy regulations requiring that patient data is carefully collected, access is controlled and is otherwise protected from the point of collection and thereafter. These regulations have or are being developed as a result of a general shift in public policy that recognizes the autonomy of the patient. That is, the patient's right to control what happens to their body and who has access to their medical information is increasingly being protected by regulations.

Practically speaking, for the medical practitioner, dealing with the myriad of regulations is very time-consuming. However, and most importantly, the regulations can affect the medical outcome of the patient as dealing with regulations slows down the practitioner in the delivery of the medical procedure.

In addition, while most people are concerned about the privacy of their personal health information (PHI) and other legal issues surrounding their receipt of medical services, the extent of this concern extends only to the extent that it will not interfere with the delivery of medical services in time-sensitive situations. Moreover, for the majority of people they would not consider that their past medical history is interesting enough for them to be overly concerned about maintaining strict privacy regarding their personal medical information. That is, most people don't have “anything to hide”, and are generally not worried or concerned about any potential embarrassment associated with their medical records being seen by others. This is also more likely to be the case in older patients who are simply concerned about receiving timely and well-informed medical services if and when they need them and who are generally willing to waive any legal issues around consent and/or privacy.

In other words, ultimately most people who are suffering from a heart attack or stroke do not want their treatment delayed in any manner whatsoever as a result of a practitioner's or facility's concern over certain legal issues.

However, at one end of the spectrum, many patients have other concerns regarding the treatments they receive. These may include concerns about their quality of life after a significant medical event such as a stroke or heart attack. That is, many patients may wish to limit treatment if a medical event, based on the estimation of their doctor(s) that their likely quality of life following treatment will be sufficiently poor or undesirable that treatment would not be wanted. Other reasons for wishing to limit treatment may be to reduce family suffering as well as economic implications around living with an undesired quality of life. As a result, many patients have prepared advance directives that have been carefully considered in regards to quality of life and these other reasons and have had those wishes prepared in the form of appropriate documents.

However, such wishes and instructions are sometimes not readily available when needed due to any number of reasons including circumstances surrounding the medical event, the location and access to the advance directives, and/or failure to communicate such wishes to family members or loved ones. Moreover, family members or loved ones, may themselves not have the resources available to educate themselves in advance of a loved ones wishes and may inadvertently cause undesired treatments because such resources have not been available. Thus, while advance directives can be an important component of the pre-treatment procedures, the accessibility of advance directives to family members and doctors is limited in many circumstances.

Further still, with or without advance directives, understanding a patient's wishes can be complicated by various factors including an increasing prevalence of dementia, which can lead to uncertainties and hence, delays in making treatment decisions. Prior to the onset of dementia, or afterwards, powers of attorney can be implemented to assist in making decisions on behalf of a patient. However, as with advance directives, the availability and/or access to such documents can lead to delays.

As a result, there has been a need for systems and tools that enable patients, at the appropriate time, to educate them and their families with regards to the options regarding their various wishes and to enable the effective creation, communication and access to the documents supporting those wishes such as advance directives and powers of attorney.

Further still, cultural overlays with regards to the manner in which decisions are made with a family are changing. Increasingly, for example, children are more involved in the health care of their aging parents. Multiple children may be involved in the health care of their parents but the ability to communicate amongst the children with regards to their parents' health care can be complicated by different children living in geographically separated locations. As a result, there has been a further need for systems and methods enabling multiple parties (professional care givers and family members) to readily communicate with regards to one or more patients' health care wishes and treatments and otherwise become involved in the successful management of ongoing medical issues and medications. As such, there is need for an internet based database that allows efficient and up to date communication between all care givers.

Still further, in some jurisdictions, a concern over PHI privacy has caused the implementation of policies that has limited the use of technology in delivery of health care. For example, in New York City, the use of cell/smart phones in ambulances has been prohibited due to PHI privacy concerns. Thus, first responders who may be seeking a physician's advice or looking to report patient data from a smart phone during the transport of a patient are prohibited from doing so. While other technologies besides cell phones, for example walkie-talkies can be used, walkie-talkies do not have the functionality of a smart phone.

As a result, there has been a need for systems and methods that enable a practitioner to initiate medical treatment more quickly by having the patient pre-authorize or provide pre-consent to the practitioner or facility to initiate treatment. In addition, there has been a need for a medical information system that enables patients to more actively control their medical information and consent through active control of their medical records. Further still, there has been a need for systems and methods that enables a patient (and/or those acting on behalf of the patient) to obtain medical data about the patient and organize and present that data to other parties (including good Samaritans, paramedics and physicians) and organize the medical data in a manner that relevant medical data pertaining to an emergency is presented.

### SUMMARY OF THE INVENTION

In accordance with the invention, systems and methods of obtaining and displaying medical information about a patient are described.

In a first aspect, the invention provides a method of obtaining medical data about a patient from a first party, the first party including any one of or a combination of the patient and one or more other persons, and presenting specific medical data pertaining to one or more medical conditions about the patient to another party, the method of obtaining and presenting occurring through a computer network, the method comprising the steps of: a) enabling the first party to access an input system, the input system enabled to enroll a patient within a medical information system operably connected to the computer network; b) enabling the first party to input medical data about the patient into the medical information system, where the first party provides an answer to individual questions of a pre-set series of questions displayed to the first party and wherein at least one individual question has a pre-set selection of answers associated with each individual question; c) applying at least one pre-set rule to each individual question, wherein a pre-set rule will flag the answer to an individual question as being relevant or not-relevant to one or more of a set number of medical conditions to a create flagged answer; d) placing a flagged answer marked as relevant within a document template associated with a specific medical condition; e) on a computer device operatively linked to the medical information system, displaying access information describing at least one of the set number of medical conditions; f) displaying a document template on the computer device, the document template having at least one flagged answer marked as relevant displayed therein and wherein the document template is associated with a specific medical condition and is displayed when access is gained via step e).

In another embodiment, the set number of medical conditions displayed on the computer device are identified as relating to any one of or a combination of “Stroke”, “Heart Attack”, “Anaphylaxis”, “Trauma”, “Asthma”, “Seizure”, “Insulin”, “Unconscious”, “Poisoning”, “Animal Bite” and “Insect Bite”.

In one embodiment, the method further includes the steps of b1) enabling the first party to input advance directive data from the patient into the medical information system into a patient record within the medical information system and e1) on a computer device operatively linked to the medical information system, displaying access information to the advance directive data from the patient within the patient record and f1) displaying the advance directive data from the patient when access is gained through step e1).

In one embodiment, the advance directive data includes any one of or a combination of text, audio or video data.

In another embodiment, the advance directive data includes any one of or a combination of a living will, a power of attorney, general consent, specific consent, consent for medical trials and consent for organ transplantation.

In one embodiment, the individual questions of a pre-set series of questions comprise a questionnaire and wherein the questionnaire includes groups of individual questions relating to a category of medical data that are presented to the first party sequentially in accordance with a pre-set order, the method further comprising the step of when an answer to a question is marked as not-relevant, additional questions within a group are not displayed and a first question within another group is displayed.

In yet another embodiment, step b) includes enabling the first party to input advance directive data relating to a patient into the medical information system where the first party provides an answer to individual questions of a pre-set series of questions displayed to the first party and wherein at least one individual question has a pre-set selection of answers associated with each individual question.

In another embodiment, the another party is identified as any one of or a combination of a Good Samaritan and medical professional. In one embodiment, a medical professional is identified as a physician and a first responder.

In another embodiment, the method further comprises the step of b2) enabling the first party to input medical data about the patient into pre-set medical categories.

In yet another embodiment, the pre-set medical categories include any one of or a combination of blood, cardiac, neurological, surgeries, images, medications, treatments, acute conditions, chronic conditions.

In another embodiment, the method further comprises the step of b3) wherein a pre-set rule includes applying a weighting factor to a flagged answer marked as relevant to determine the relative importance of a flagged answer and f2) displaying a document template containing data having a weighting factor above a pre-determined threshold in a prominent position when access is gained through step e).

In another embodiment, the method further comprises the step of b4) applying one or more additional pre-set rules to one or more flagged answers marked as relevant and based on those additional pre-set rules applying additional weighting factors to prioritize the display of particular data through the at least one computer device.

In another embodiment, the method further comprises the step of displaying prioritized data in distinct categories, where each category has a threshold for display of prioritized data in a specific category based on the pre-set rules.

In one embodiment, the pre-set series of questions displayed to the first party include any combination of questions relating to contraindications to magnetic resonance imaging, past surgeries of the patient, active insurance information of the patient, and/or questions relating to providing instructions to a Good Samaritan.

In another embodiment, the method further comprises the step of limiting access to the medical information system through the computing device and wherein the step of limiting access requires biometric information from the patient to be entered prior to gaining access through the computing device. The biometric information includes any one of or a combination of a fingerprint scan, retinal scan, facial recognition, hand geometry, and vein pattern recognition in one embodiment.

In another embodiment, the method further comprises the step of when a first responder or a physician has activated the system, the first responder or physician further identifies themselves to the system and a medical facility associated with the first responder or physician is given access to a patient's medical information within the medical information system when the first responder or physician is recognized as being previously enrolled with the system.

In another embodiment, the method further comprises the steps of associating a date with a flagged answer marked as relevant, monitoring the age of a flagged answer marked as relevant and applying a further pre-set rule associated with the flagged answer marked as relevant, and forwarding an electronic notice to the first party if a pre-determined time period has elapsed, the electronic notice advising the first party of an age of the flagged answer marked as relevant.

In another embodiment, the method further comprises the steps of: a) enabling a first party to enter travel data into the medical information system including a departure date, at least one travel destination and at least one return date; b) comparing the at least one travel destination to a database containing advance directive requirements for a jurisdiction to determine advance directive requirements for the patient for the at least one travel destination; c) comparing advance directive requirements for the at least one travel destination against a suitability of existing advance directives within the medical information system for a patient wherein any advance directives within the medical information have been previously flagged as suitable or not-suitable for a jurisdiction; and d) initiating communication with the first party to inform the first party if existing advance directives are suitable or not-suitable for the at least one travel destination.

In another embodiment, the method further comprises the steps of: a) enabling a first party to register a patient's mobile device having location determination functionality with the medical information system and associating the mobile device with the patient within the medical information system; and b) when the mobile device is accessed and activated during an emergency, reporting the location of the mobile device to the medical information system.

In another embodiment, the method further comprises the steps of: when the location of the mobile device is reported to the medical information system, the medical information system searches a database of medical facilities, determines a list of medical facilities closest to the mobile device and provides instructions to the mobile device to display a list of medical facilities in order of proximity to the mobile device.

In another embodiment, the method further comprises the steps of: activating map and route software on the mobile device to display a route to at least one of the closest medical facilities.

In one embodiment, the medical information system compares the type of medical emergency that is occurring with the patient against the database of medical facilities wherein the database of medical facilities includes information about the capabilities of a medical facility to treat specific medical conditions, and the medical information system determines the closest medical facility capable of treating the patient for an identified emergency medical situation.

In another embodiment, the method further comprises the steps of: when the location of the mobile device is reported to the medical information system, the medical information system searches a database of medical equipment, determines a list of medical equipment closest to the mobile device and relevant to an identified emergency medical situation, and provides instructions to the mobile device to display a list of medical equipment in order of proximity to the mobile device.

In another embodiment, the method further comprises the steps of: activating map and route software on the mobile device to display a route to at least one of the closest medical devices.

In one embodiment, the medical equipment includes any one of or a combination of a defibrillator kit, a first aid kit, an anti-poisoning kit, and an angina treatment kit.

In another aspect, the invention provides a method of obtaining advance directive data about a patient from a first party, the first party including any one of or a combination of the patient and one or more other persons, and presenting advance directive data about the patient to another party, the method of obtaining and presenting occurring through a computer network, the method comprising the steps of: a) enabling the first party to access an input system, the input system enabled to enroll a patient within a medical information system operably connected to the computer network; b) enabling the first party to input advance directive data about the patient into the medical information system where the advance directive data is an electronic advance directive file containing information for any one of or a combination of a patient's living will, power of attorney, general consent, specific consent, consent for medical trials, and consent for organ transplantation; c) placing the electronic advance directive file within a patient record within the medical information system; and, d) on a computer device operatively linked to the medical information system, displaying access information enabling another party to access each of the patient's electronic advance directive files within the patient record.

In one embodiment, the electronic advance directive file is any one of or a combination of a text, audio and video file.

In yet another aspect, the invention provides a system for obtaining medical data about a patient from a first party, the first party including any one of or a combination of the patient and one or more other persons, and presenting specific medical data pertaining to one or more medical conditions about the patient to another party, the system comprising: a computer database operatively connected to a computer network, the computer database having an input system enabling the first party to enroll a patient within a medical information system (MIS) through a local or remote computer interface; the computer database further having a medical data module enabling the first party to input medical data about the patient into the medical information system, where the medical data module enables the first party to provide an answer to individual questions of a pre-set series of questions displayed to the first party and wherein at least one individual question has a pre-set selection of answers associated with each individual question; the medical data module further applying at least one pre-set rule to each individual question, wherein a pre-set rule will flag the answer to an individual question as being relevant or not-relevant to one or more of a set number of medical conditions to a create flagged answer and placing a flagged answer marked as relevant within a document template associated with a specific medical condition; at least one computer device having hardware and software enabling: a) the at least one computer device to operatively connect to the medical information system; b) displaying access information describing at least one of the set number of medical conditions and enabling access through an access information display; and c) displaying a document template having at least one flagged answer marked as relevant wherein the document template is associated with a specific medical condition and is displayed when access is gained through the access information display.

In one embodiment, the set number of medical conditions displayed on the computer device are identified as relating to any one of or a combination of “Stroke”, “Heart Attack”, “Anaphylaxis”, “Trauma”, “Asthma”, “Seizure”, “Insulin”, “Unconscious”, “Poisoning”, “Animal Bite” and “Insect Bite”.

In another embodiment, the medical data module further enables the first party to input advance directive data from the patient into the medical information system into a patient record within the medical information system and on a computer device operatively linked to the medical information system is enabled to display access information to the advance directive data from the patient within the patient record and to display the advance directive data from the patient when access is gained through the access information display.

In yet another embodiment, the advance directive data includes any one of or a combination of text, audio or video data.

In one embodiment, the advance directive data includes any one of or a combination of a living will, a power of attorney, general consent, specific consent, consent for medical trials and consent for organ transplantation.

In one embodiment, within the medical data module, the individual questions of a pre-set series of questions comprise a questionnaire and wherein the questionnaire includes groups of individual questions relating to a category of medical data that are presented to the first party sequentially in accordance with a pre-set order, and wherein the medical data module, when an answer to a question is marked as not-relevant, additional questions within a group are not displayed and a first question within another group is displayed.

In one embodiment, the medical data module enables the first party to input advance directive data relating to a patient into the medical information system where the first party provides an answer to individual questions of a pre-set series of questions displayed to the first party and wherein at least one individual question has a pre-set selection of answers associated with each individual question.

In another embodiment, the another party is identified as any one of or a combination of a Good Samaritan and medical professional on the at least one computer device.

In one embodiment, a medical professional is separately identified as a physician and a first responder.

In one embodiment, the medical data module enables the first party to input medical data about the patient into pre-set medical categories.

In one embodiment, the pre-set medical categories include any one of or a combination of blood, cardiac, neurological, surgeries, images, medications, treatments, acute conditions, and chronic conditions.

In one embodiment, the medical data module applies one or more additional pre-set rules to one or more flagged answers marked as relevant and based on those rules applies an additional weighting factor to prioritize the display of particular data through the at least one computer device.

In one embodiment, within the medical data module, the pre-set series of questions displayed to the first party include questions relating to contraindications to magnetic resonance imaging, questions relating to past surgeries of the patient, questions relating to active insurance information of the patient and/or questions relating to providing instructions to a Good Samaritan.

In one embodiment, the at least one computer device includes a biometric access device operatively connected to the at least one computer device and the at least one computer device enables access to the medical information system through the computing device when pre-set biometric information from the patient is entered into the at least one computing device.

In one embodiment, when a first responder has activated the system, the system includes means for the first responder to identify themselves to the system and a medical facility associated with the first responder is given access to a patient's medical information within the medical information system.

In one embodiment, the medical data module further enables associating a date with a flagged answer marked as relevant, monitoring the age of a flagged answer marked as relevant, applying a further pre-set rule associated with the flagged answer marked as relevant, and forwarding an electronic notice to the first party if a pre-determined time period has elapsed wherein the electronic notice advises the first party of an age of the flagged answer marked as relevant.

### BRIEF DESCRIPTION OF THE DRAWINGS

The invention is described with reference to the accompanying figures in which:

FIG. 1 is an overview of various stakeholders' involvements with a medical information system in accordance with one embodiment of the invention.

FIG. 1A is an overview of a medical information system in accordance with one embodiment of the invention.

FIG. 2 is an overview of a patient account module in accordance with one embodiment of the invention.

FIG. 3 is an overview of a medical records module in accordance with one embodiment of the invention.

FIG. 4 is an overview of a clinical situation module in accordance with one embodiment of the invention.

FIG. 4A is an overview of a clinical situation module with a display showing high level emergency categories in accordance with one embodiment of the invention.

FIG. 5 is a representative flow chart showing representative questions pertaining to neurological conditions that may be presented to a patient.

FIG. 5A is a representative flow chart showing representative questions pertaining to cardiovascular conditions that may be presented to a patient.

FIG. 5B is a representative flow chart showing representative questions pertaining to contraindications pertaining to MRI that may be presented to a patient.

FIG. 5C is a representative flow chart showing representative questions pertaining to previous surgeries that may be presented to a patient.

FIG. 5D is a representative flow chart showing representative questions pertaining to allergies that may be presented to a patient.

FIG. 5E is a representative flow chart showing representative questions relating to a patient's contacts and beliefs that may be presented to a patient.

FIG. 5F is a representative flow chart showing representative questions pertaining to advance directives that may be presented to a patient.

FIG. 6 is a representative information display showing how relevant emergency information may be presented to a treating professional in accordance with one embodiment of the invention.

FIG. 6A is a representative information display showing how relevant advance directive information may be presented to a treating professional in accordance with one embodiment of the invention.

FIG. 6B is a representative information display showing how relevant emergency information may be presented to a Good Samaritan in accordance with one embodiment of the invention.

FIG. 7 is an overview of an advance directive module in accordance with one embodiment of the invention.

FIG. 8 is representative information display that may be presented in accordance with one embodiment of the invention.

FIG. 9 is a flowchart showing the generalized functionality of the input, back-end and output sides of the system in accordance with one embodiment of the invention.

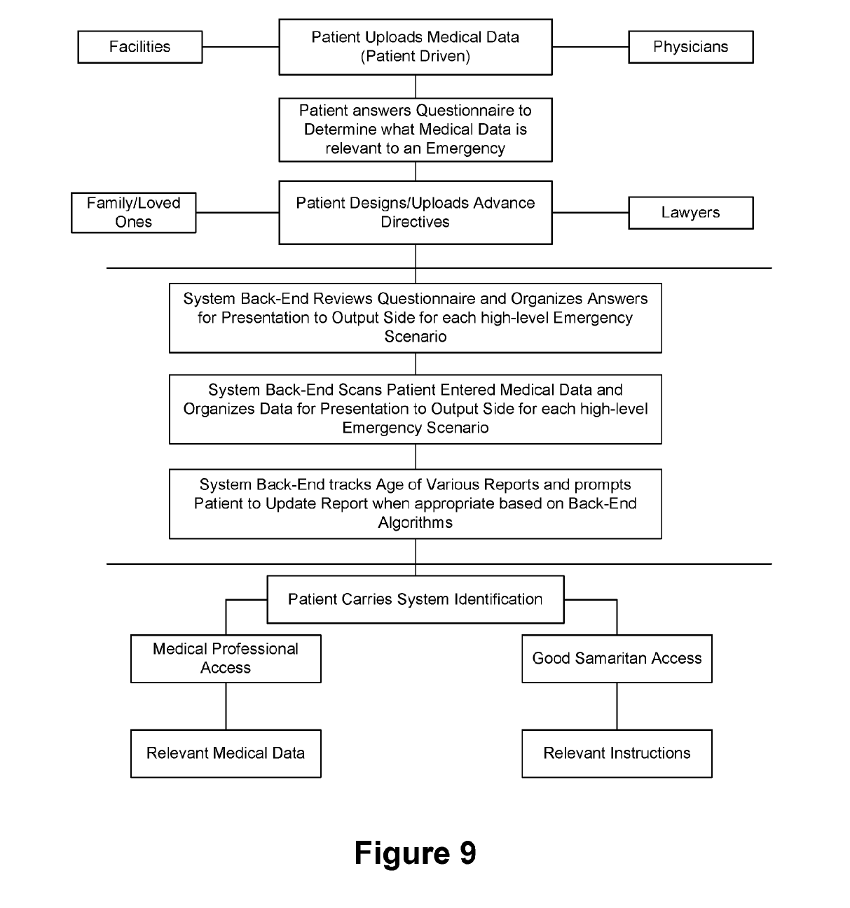

FIG. 10 is a flowchart showing the generalized functionality of rules being associated with questions and how those rules are applied to determine publication of relevant data.

### DETAILED DESCRIPTION OF THE INVENTION

With reference to the figures, systems and methods for obtaining, maintaining, organizing and accessing medical information about a patient is provided. More specifically systems and methods for gathering and presenting medically important and time-sensitive medical information that is relevant to a general class of medical emergency are described. In a broad sense, the systems and methods gather and present information so as to provide a platform that can be used improve the efficiency and timeliness of medical decisions in accordance with a patient's wishes. In addition, and more specifically, systems and methods of providing pre-consent for medical practitioners to conduct medical treatment as well as systems and methods providing ready access to a patient's advance directives are described. In addition, systems and methods of ranking medical information that may be relevant to an emergency situation are described. In its various embodiments, the systems and methods described herein can be used to improve decision making by medical practitioners, can save time in the diagnosis and treatment of patients, and be used to assist in patient education as well as to promote communications between patients, their families and medical practitioners.

The system 10 includes an internet-based database and website with an input side allowing patients (and/or their families/loved ones and/or other authorized parties) to create a patient profile that includes information about the patient including basic patient identifying information, their medical records, as well as consent/advance directive information. The system also includes an output side that enables practitioners and/or medical facilities and/or good Samaritans to gain access to that information. In addition, the system allows patients to centrally locate their medical records. In a preferred embodiment, the system is patient-driven that allows the patient to control the various levels of access to their consent records and medical records. In one specific embodiment, the system organizes and presents medically important and time-sensitive information in a manner that allows physicians ready access for the purposes of expediting diagnosis and treatment particularly during emergencies.

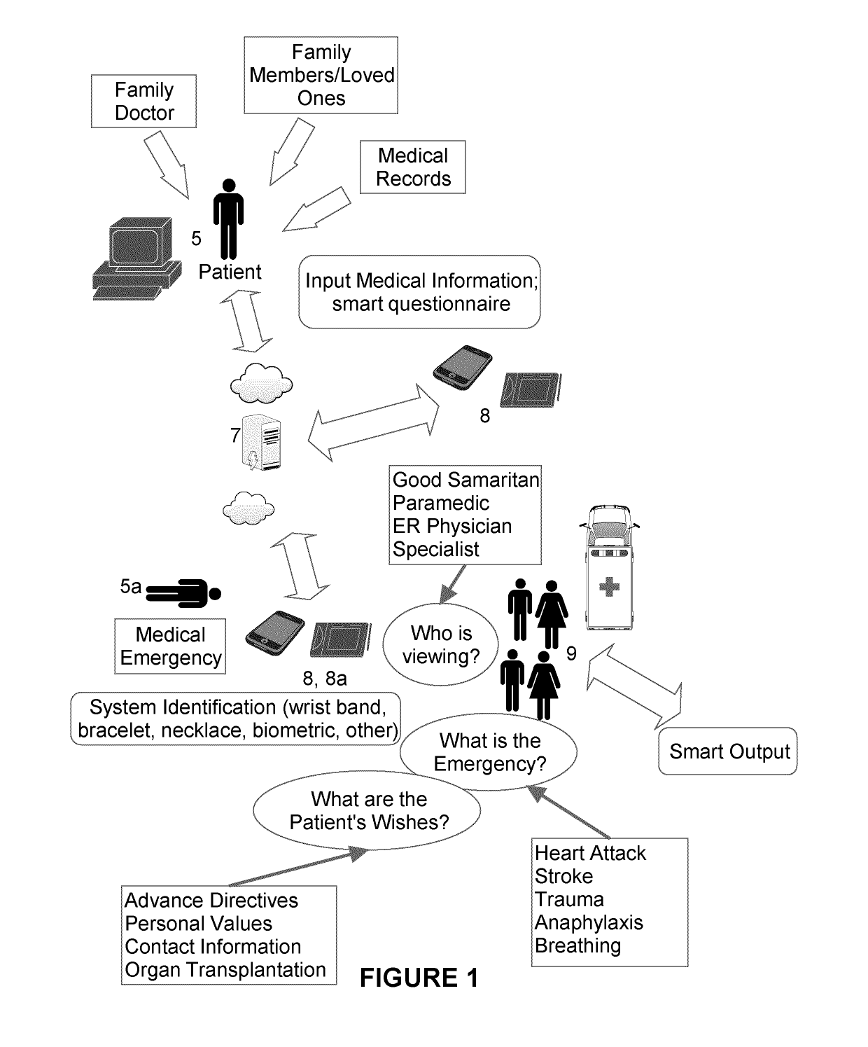

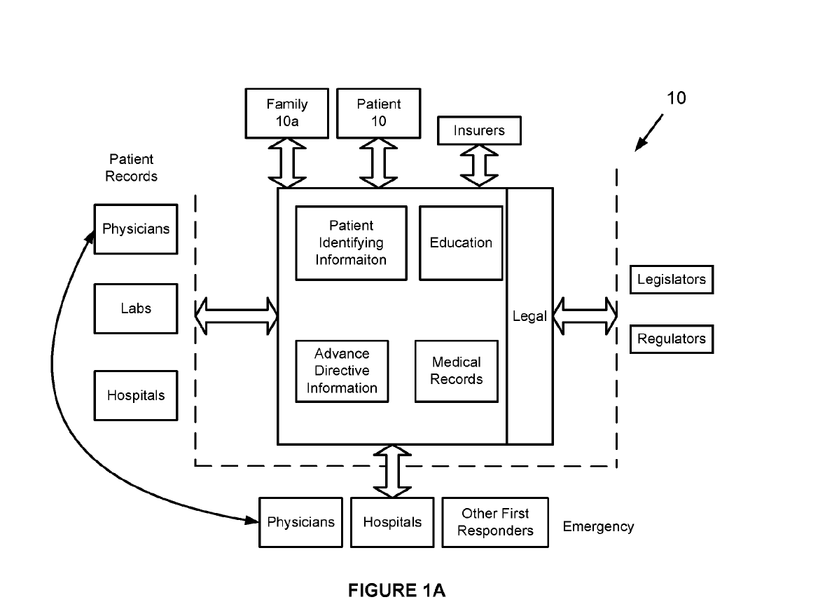

FIG. 1 shows schematically how various stakeholders can interact with the system. As shown, the system has both an input side where a patient 5 (or other persons representing a patient such as family members and/or physicians) 5 interacts with a computer 6 to create a user profile thereby enabling the patient (or other authorized person) to interact with the system and inter alia upload their medical records to a central database 7 (i.e. input side). As explained in greater detail below, there are multiple functions within the system that obtain and organize a patient's medical data which may include medical information in a standard form and/or medical information obtained through a smart questionnaire. After a medical history/data has been uploaded, a patient's mobile devices (e.g. smart phone, tablet, laptop etc.) 8 may be linked to the patient's records such that access to these records can be obtained from the patient's mobile devices 8 or other devices 8a not linked to the patient but that have the appropriate access authorized (i.e. the output side).

If the patient 5a subsequently has a medical emergency, any of first responders, physicians and medical facilities (collectively medical practitioners/professionals) and/or good Samaritans 9 can access the patient's records through the appropriate computing devices 8, 8a. In a preferred embodiment, the most relevant medical data to the patient's emergency is presented based on a logical display of high-level choices that are shown to the medical professionals or Good Samaritan. The presentation of data can be used by a medical professional to make a diagnosis and/or initiate a treatment more efficiently as compared to when this information is not available. The presentation of data can be used by a Good Samaritan to take appropriate steps that may assist the patient.

FIG. 1A shows a general overview of the various users/stakeholders and the inter-relationships between these parties within the system. As noted above, the system generally allows for increased and efficient communication between stakeholders including the patient and the medical team during an emergency. In addition, the system allows storing information that is patient-driven and provides systems and methods for efficient recovery of information by the medical team if and when such information is needed.

As noted, the system includes a central database that contains and controls access to that information from a variety of users including the patient, the holders of a patient's medical records including physicians, labs and hospitals and those medical practitioners/facilities who may be treating the patient in an emergency. In addition, other users including insurers (and financial advisors/managers) and legal personnel may interact with the system. Generally, the functionality of the database is described in the context of a single patient whose medical information is maintained within the database together with the various medical practitioners or facilities where medical information is derived as well as the various medical practitioners and facilities that require information from the database. It is understood that the system is designed to maintain and provide access to the medical, personal and advance directive information for a large number of patients. In addition, the system is also described under various situations or scenarios where a patient and/or family/loved ones may interact with the system.

### Patient Account Module

Initially, and usually, a patient 10 interacts with the database, referred to herein as a medical information system (MIS), to establish an account; however under some circumstances legal representatives and/or other users may undertake such actions on behalf of a patient. In the following description, it is assumed that the patient is interacting with the system. Preferably, the database is an electronic database that is operatively connected to a website enabling users to enter information from remote internet-connected computers accessing the website. In the context of this description, the manner in which users interact with the system is generally described as being a web-enabled system and is described in that general manner. However, aspects of the system may involve other interfaces enabling a patient to interact with the system. For example, the system may enable a patient to contact a call-center where call-center staff would receive information over the phone who would enter data into the system. Further, a patient or user may interact with the system utilizing specific hardware that is designed to interface with the system as described in greater detail below.

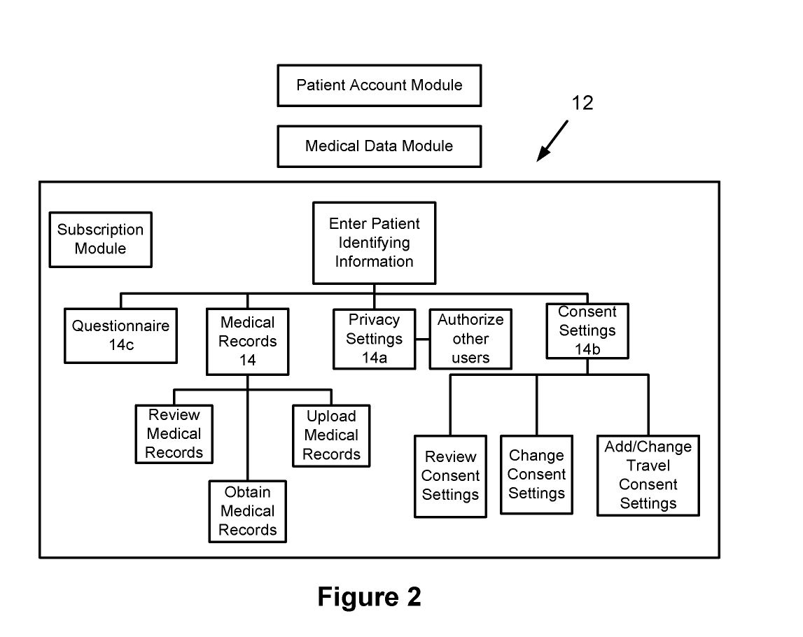

When a patient desires to open an account, the patient accesses the website where they access a Patient Account Module (PAM) 12 (FIG. 2) within the MIS. The PAM generally enables a patient to enter the appropriate personal information including name, address, photograph and other appropriate information including the names and addresses of their various physicians and/or local treatment facilities as well as family members and/or loved ones 10a. Once a basic account is established (including establishing or making a payment for use of the system if so configured with a subscription module or the like), the patient is provided with access to various modules including a medical data module 14, privacy settings module 14a, consent settings module 14b and questionnaire module 14c.

### Medical Data Module

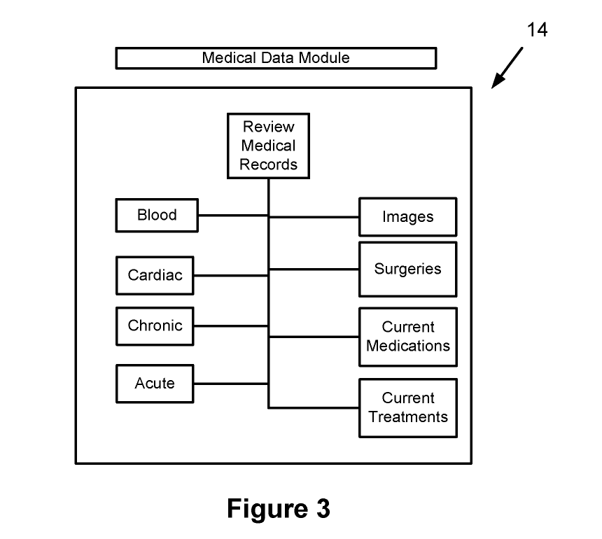

With the medical data module 14 (FIG. 3), the patient can generally review existing medical records (if previously loaded), upload new medical records and/or obtain medical records that the patient may wish to upload. Generally, medical records will be organized according to date and type. For example, as shown in FIG. 3, specific medical records may be accessed through general categories such as blood reports, surgeries, current medications etc. By accessing a specific category such as blood reports, a chronological list of reports from most recent to oldest may be listed. Accessing a specific blood report will present the data of that report. That data may be presented as a scan of a paper file or may be presented as a standardized form such that the data appears consistent across multiple reports and can thereby be organized within the database such that searching and the application of pre-determined rules (explained below) may be applied.

Similarly, other data such as image data and associated reports may be accessed by accessing the appropriate category of data.

Other functionality may be provided including the ability to upload new medical records to an appropriate category of data and/or the ability to initiate a process to obtain medical records. Uploading new medical records may be patient-driven or may be system-driven or a combination of both depending on deployment. For example, if a patient has in their possession an e-file of an x-ray, the system may enable them to upload that image (and associated report) to the appropriate category by following an appropriate series of prompts. Alternatively, the system may enable a basic upload of data to a holding location wherein system support staff review and categorize the record to ensure its proper categorization.

Further still, the system may allow a patient to initiate system processes to obtain a medical record from a physician or facility. For example, if the patient has recently been seen by a physician and wants to upload new medical data to the system, they can use system functionality to obtain the information. Depending on the jurisdiction and jurisdictional requirements for the release of medical information, such processes may require direct patient involvement in the transfer of a medical record from one location to another. Release of information may require a patient signature and may require that the request for the transfer of information be transmitted by fax machine. Further, different facilities may utilize different protocols that may be confusing and time-consuming to the patient to navigate through to obtain their medical information. Thus, the system may facilitate the transfer of information by prompting the patient to enter requested information on a transfer form that is processed automatically or semi-automatically by the system.

In one embodiment, the system generates a letter requesting a medical practitioner/facility to transfer information and depending on the particulars, automatically send a request directly to a medical practitioner/facility. Alternatively, the system may generate a letter that is forwarded to the patient for them to forward to the medical practitioner/facility. In either event, the system's database will maintain templates that may be specific to the type of information being requested and from which medical practitioner/facility. Importantly, as the system develops, relationships with various medical practitioners/facilities, the various templates and communications requests will follow known processes and procedures, which will streamline the process.

Other functionality may be included if necessary to verify the authenticity of a request by introducing a verification process with the patient. Such verification could include procedures to verify instructions over the telephone but can also include systems that utilize biometric verification as discussed in greater detail below.

As patients/users become more familiar with the system, patients carry with them letters/forms/instructions to each medical appointment they attend with instructions to forward the appropriate reports from an appointment to a specific email and/or fax address.

Depending on the implementation, the system will preferably send regular reminders to a patient and/or physicians to maintain an updated record. That is, the system can monitor the frequency with which patient's are updating their records and at regular intervals and/or after a period of dormancy, send a reminder via email, text messaging or other procedure.

Importantly, different medical records may have varying time validity which may be flagged by the system using different markers indicating that a specific time period has elapsed since the record was obtained. This may be used to ensure that there is no confusion by a reviewer with regards to the validity of a record.

The foregoing description of uploading and maintaining medical records is primarily applicable for the patient to ensure that their complete medical history is being centrally located and appropriately managed by a central system. These records as described may be useful for the patient/stakeholders to gain access to during a variety of medical situations that extend beyond emergency situations.

While it will generally be preferable that the patient maintains a complete medical record, in some embodiments, it is also preferable that the records only contain relevant information that may be applicable to a medical emergency or that the system determines will have no relevance. Thus, the system may also include functionality in the form of rules that will determine if it is worthwhile for the patient to upload that data. For example, blood reports from several years ago, that are “normal” would generally not be required under any scenario. Similarly, in some embodiments, where a patient is only interacting with the system in anticipation of using the system to assist in emergency situations only (i.e. not for the purposes of maintaining a medical record per se), the system may have underlying rules that question and/or state to the patient that uploading a specific type of information is likely not going to be relevant to a future emergency situation. Similarly, this type of assessment may be done by call center personnel and/or other personnel who review the patient's information and advise whether such information is relevant or not.

That is, in another embodiment and as described in greater detail below, the medical records module can also be used to prompt the user to answer questions regarding their current and past medical conditions that may be relevant to a future emergency through the questionnaire module 14c. For example, questions such as “Have you had any significant change in your medical condition since your last update of ‘date’?” or “Have you had any new investigations since ‘date’?”. Yes answers to these questions will generally prompt additional questions to ensure that the new information is uploaded to the system. Similarly, in one aspect of the invention, where patients are invalid and/or have involved family/loved ones in the system, the system may be set up to send reminders to authorized family members/loved ones who may then take the steps to update the information.

### Clinical Situation Module or Medical Questionnaire Module 14c

In another embodiment, the system includes a clinical situation or medical questionnaire module 14c that enables a treating professional (or Good Samaritan in some scenarios) to obtain relevant information about the patient particularly during an emergency.

Generally, a treating professional does not want to hunt through data but rather needs key questions about the patient's history to be answered quickly and presented to the treating professional in a logical manner.

For example, during an emergency, if by means of a personal data device such as a smart phone, tablet, laptop or other computing devices, the treating professional has access to a screen or screens that promptly presents the most relevant medical information that may be applicable to an emergency situation, the time for diagnosis and treatment will be reduced significantly.

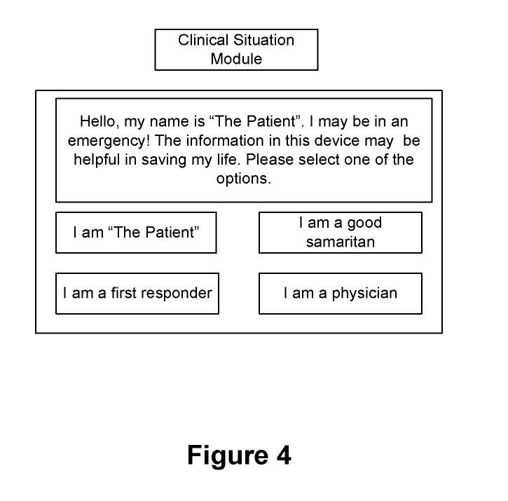

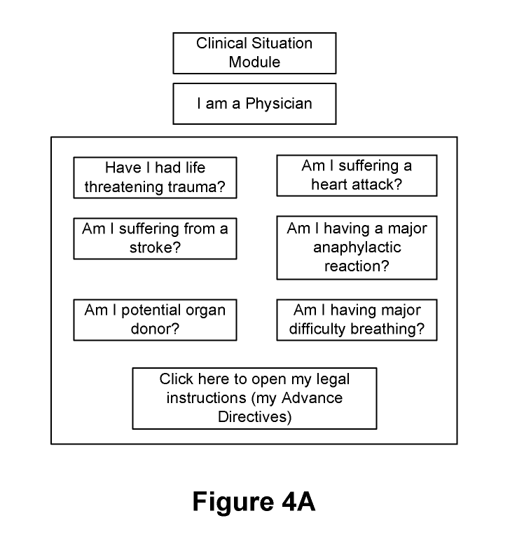

As an example, a patient may suddenly suffer a heart attack in a public location. The patient is carrying a smart phone, and may be wearing a bracelet or other notification system that indicates there is relevant and important information for an emergency on their smart phone and/or accessible from a remote account. When activated and/or accessed, and as shown in FIG. 4, this may be displayed on a screen as soon as a first responder determines there is an emergency situation and has activated the device. As shown in FIG. 4, the first responder may be initially be presented with an initial message stating that an emergency could be occurring and that the information within the computing device could help save the patient's life. Initially, it will be preferred to identify the type of person who may be responding such as the patient themselves, a first responder (e.g. a paramedic), a physician or a Good Samaritan. It should be noted that the computing device (smart phone or otherwise) may include functionality that bypasses any passwords on the computing device to gain access to the system's functionality.

By selecting the option that is most appropriate for the situation, information relevant to the knowledge of the individual can be more efficiently presented.

For example, as shown in FIG. 4A, if the person accessing the system is a physician, the physician would be able to affect a broad class diagnosis based on the situation at hand, such as the patient having a stroke, heart attack, significant trauma or an anaphylactic reaction. Other emergency scenarios could also various conditions such as asthma, seizure, insulin issue, unconsciousness, poisoning, animal bite, insect bite, etc. By clicking on the broad diagnosis, and as explained in greater detail below, the most relevant information for that clinical situation would be presented.

Obtaining and organizing the medical information that may be appropriate to the clinical situation will now explained.

During initial set-up with the system, and at various intervals thereafter, a patient is asked to complete and/or update a medical questionnaire that is used to identify relevant medical information for the purposes of presenting that information to different persons when an emergency might be occurring.

A questionnaire will be of a form that asks the patient about their medical history which is connected to a computer back-end (e.g. the database) within the MIS that organizes the answers/information provided by the patient to the various broad category clinical situations that could ultimately occur.

The questions within the questionnaire are generally organized to obtain information about medical conditions relevant to each of the body's systems as well as systemic conditions, past and recent surgeries, past and current medications, results of recent tests, contraindications for imaging technologies as well as non-medical history information such as insurance information, advance directives (including consent), emergency contacts, and organ transplantation instructions.

By way of example, the questionnaire may be organized to include questions about the main body systems and/or conditions including neurological, cardiovascular, chest and pulmonary, gastrointestinal, urological, gynecological and woman's health, hematological and musculoskeletal systems and/or conditions as well as questions about oncological conditions and systemic conditions including anaphylaxis and asthma and autoimmune disorders. Preferably, the questionnaire is an electronic questionnaire that has underlying functionality such that answers provided indicating that a condition does not exist (or not relevant) will automatically advance the questionnaire to a further set of questions.

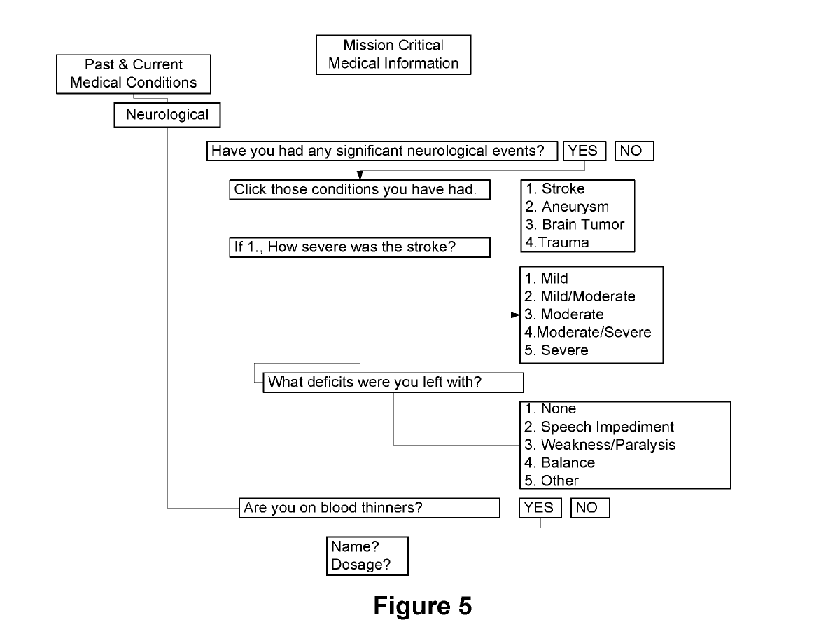

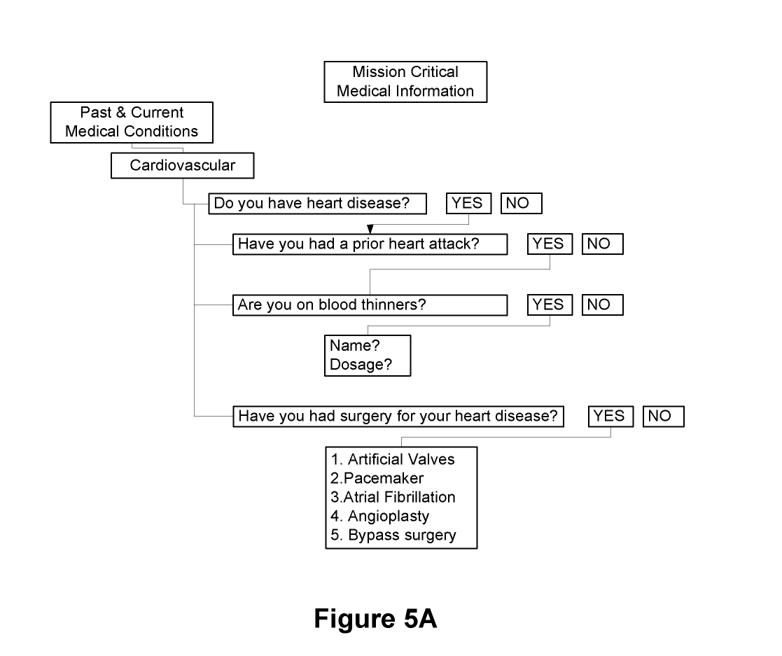

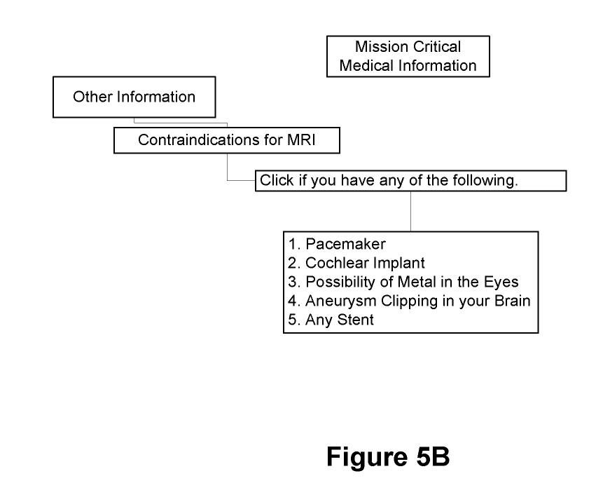

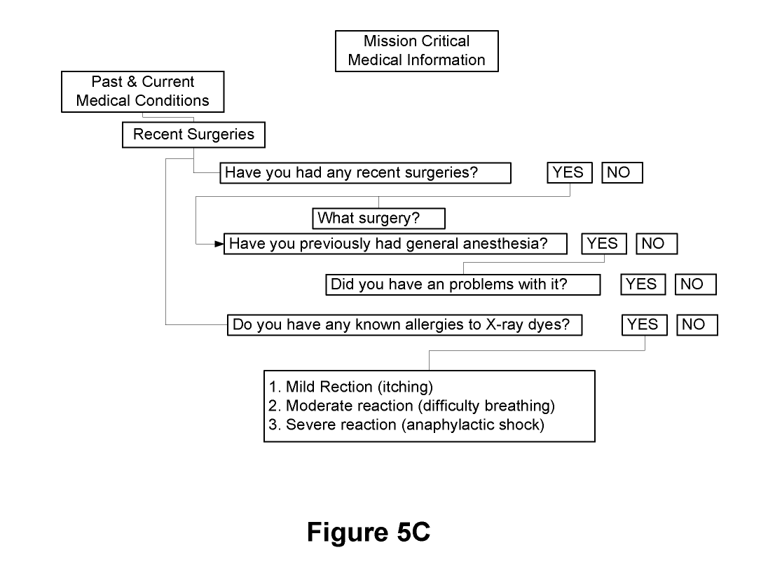

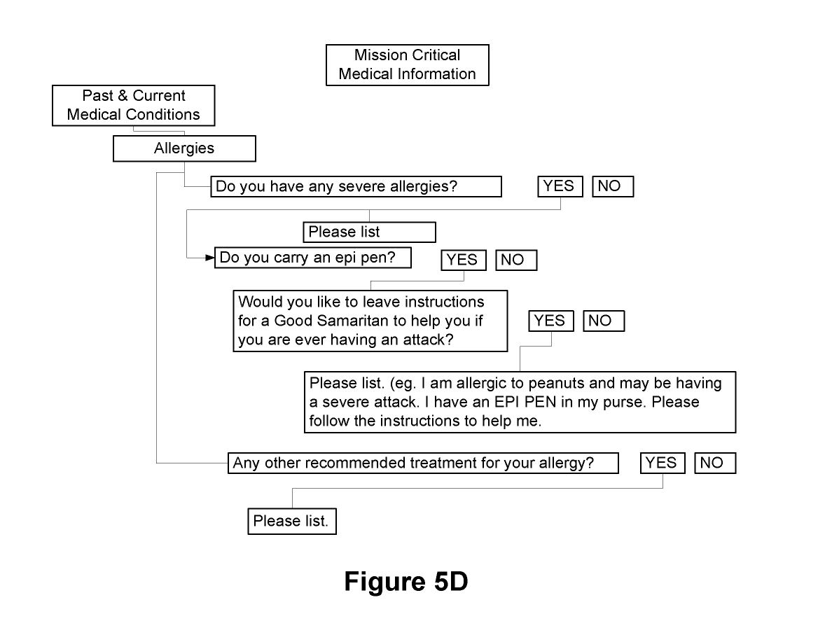

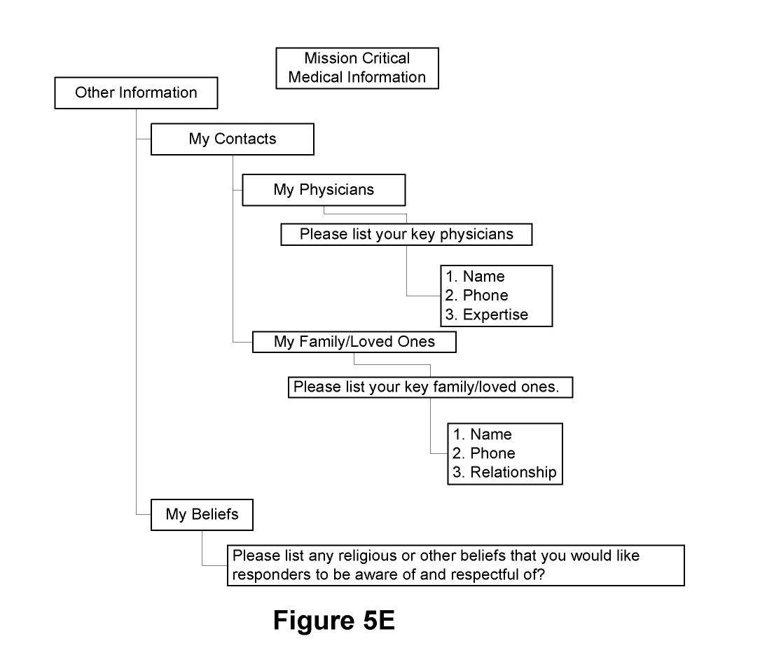

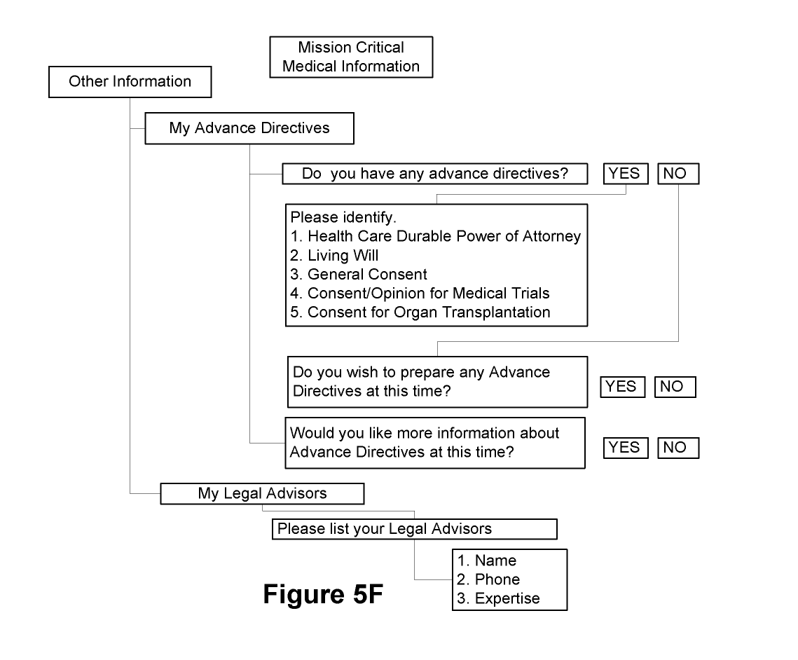

As shown in FIG. 5, a representative series of questions seeking to obtain information about the neurological history of a patient may be as follows: “Have you had a significant neurological condition?” Yes or No?. If No, the system will advance to the next set of questions. If Yes, a question may ask the patient to check or identify each of the various neurological conditions that they may have had such as previous stroke, brain tumor, aneurysm, past trauma etc. For each condition that may have been checked a series of follow-up questions may be asked. For example, if the patient has had a stroke additional questions may include “How severe was the stroke?” with a drop down box for the patient to select its relative significance such as minor, minor to moderate, moderate, moderate to severe and severe. Further questions might include “What deficits were you left with after the stroke?” with a drop-box with answers such as no deficit, speech problem, weakness on one side of the body, balance problem etc.

Another question, might be “Are you on blood thinners?” with a drop down box for the patient to select one or more of the most common drugs with additional questions asking about dosage and dates.

In each case, questions that confirm or identify a condition will generally be linked to additional questions regarding the date and/or relevant time factors.

The answers to the questions are then linked to a general emergency scenario as shown in FIG. 4A. For example, a patient may have answered questions confirming that they had a previous stroke, that the stroke was moderate, that they have left side weakness, that they are on blood thinners and that they have an allergy to a common anesthetic drug.

These answers are generally relevant to the emergency scenarios of the patient having a heart attack, a stroke or in a trauma situation. These answers are less relevant to the situations of an anaphylactic reaction or a breathing problem.

In order to effectively organize the importance of each condition, the back-end system will categorize the answer to each question in a table that determines from rules associated with each question whether the answer to the question is relevant to a particular emergency condition. That is, to the extent that various questions are answered with a positive response (i.e. that a condition exists), the system's underlying functionality (e.g. rules) will apply a factor to that question for each of the main emergency clinical situations that could occur.

For example, questions and/or the answers to questions relating to the occurrence and significance of a stroke as outlined in FIG. 5 may be categorized as shown in Table 1. That is, each question will generally have one or more rules associated with it that will determine whether the answer to the question for each general category of emergency is relevant.

TABLE 1

| | | | | | Ana- | |
|---|---|---|---|---|---|---|
| | | | | Heart | phylactic | |
| # | Question/Answer | Trauma | Stroke | Attack | Reaction | Breathing |
| 1 | Have you had a | 0 | 1 | 1 | 0 | 0 |
| | stroke? Yes. | | | | | |
| | Dec., 15, 2013 | | | | | |
| 1a | Was the stroke | 0 | 1 | 1 | 0 | 0 |
| | minor or | | | | | |
| | significant? The | | | | | |
| | stroke was | | | | | |
| | Moderate | | | | | |
| 1b | Do you have any | 0 | 1 | 0 | 0 | 0 |
| | deficiencies? | | | | | |
| | Have minor left | | | | | |
| | side paralysis | | | | | |
| 2 | I am on blood | 1 | 1 | 1 | 0 | 0 |
| | thinners— | | | | | |
| | Drug X, DOSE | | | | | |
| 3 | I am allergic to | 1 | 1 | 1 | 1 | 1 |
| | drug X | | | | | |

From the above, the system will correlate the answers to the questions to each of the broad classes of emergency. For example, from the above “positive” answers, the information from these positive answers can be mapped (using a template) and presented the physician and stroke section (e.g. behind “Am I suffering a stroke” section of the physician section) of the system as follows:
Experienced moderate stroke on Dec. 15, 2013
Minor left side weakness
Currently on X drug at DOSE
Am allergic to anesthetic drug Z

In the case of the above patient presenting at an emergency ward showing symptoms of a stroke, if the physician navigates to this location (physician/stroke section), the above is presented, which may be very helpful in determining a treatment.

By way of comparison, in the case of the same patient presenting at an emergency ward showing symptoms of an anaphylactic reaction, the only information presented to a physician navigating to the anaphylactic section (from these stroke questions/answers) would be the allergy to anesthetic drug Z. In this situation, the patient would likely have answered questions in the questionnaire that indicated that they are susceptible to anaphylactic reactions and hence, other information would likely be presented at this location.

Importantly, combinations of answers may be subjected to additional weighting based on underlying logic (e.g. back end algorithms programmed) associated with those questions. For example, in the case of a patient who may have a number of conditions, positive answers to questions in different categories may cause particular combinations of questions to be summed such that the weighting factor becomes greater and hence, those answers appear higher in the list. For example, positive answers to questions 1, 2 and 3 in Table 1, may be recognized as requiring particular attention and hence should appear higher in the list.

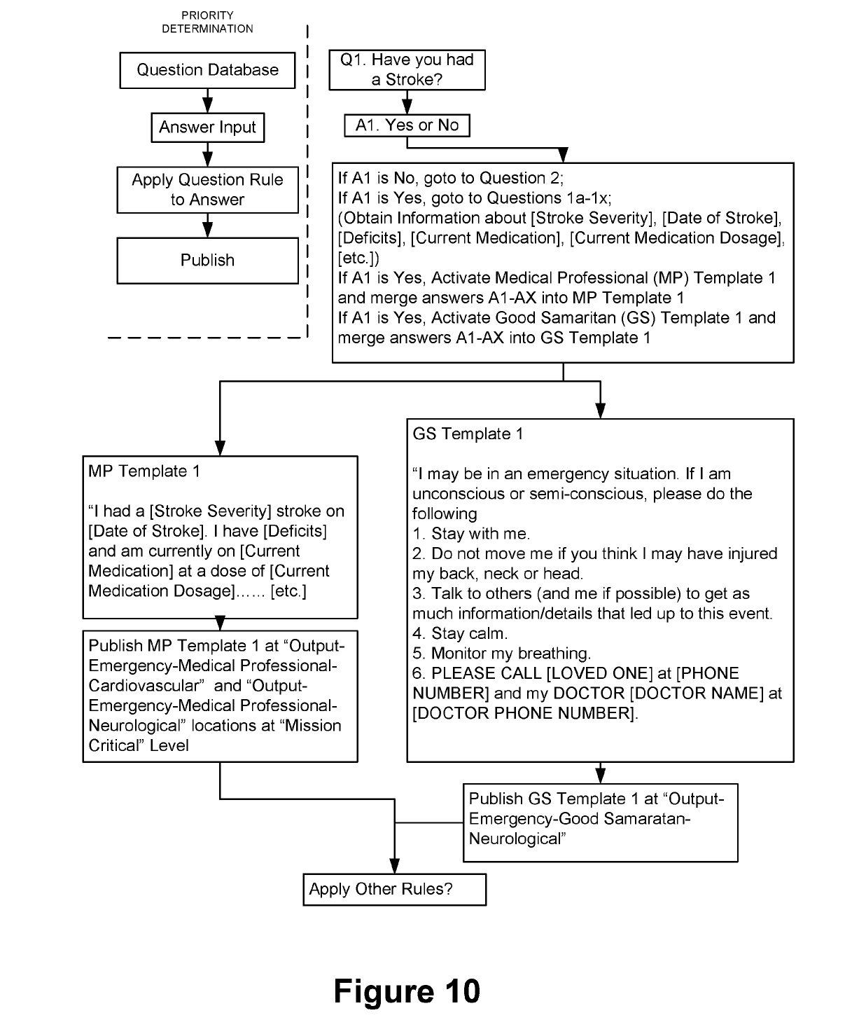

The development of the back end algorithms that evaluate the weighting factors may be relatively simple (e.g. the condition exists or not) but may also be highly sophisticated to consider various medical scenarios (e.g. the combined effects of different drugs that a patient may be taking). Importantly, the underlying logic is preferably adaptable such that an evolution in the questionnaire and/or changes in medical knowledge and/or best practices can be incorporated into the system. The correlation between a specific question and answer is described in greater detail below with reference to FIG. 10.

FIGS. 5A-5F shows other high level questions that may be presented and answered within the medical questionnaire module. It should be noted that these questions are intended only to be illustrative of the types of questions that may be answered and that may be particularly important within a general emergency situation. Significant additional detail may be incorporated into the questionnaire.

FIG. 5A shows high level questions that may be relevant to a patient with a history of cardiovascular problems.

FIG. 5B shows high level questions that would be relevant to ultimately assisting a physician who needs to know if the patient has any contraindications for magnetic resonance imaging (MRI). Positives answers to these questions when presented to a physician may substantially speed up the time to make a diagnostic imaging decision.

FIG. 5C shows high level questions that may be relevant to a patient surgical history.

FIG. 5E shows high level questions pertaining to important information regarding patient contacts including their physicians, family members and loved ones. Questions pertaining to a patient's beliefs religious or otherwise may also be presented and answered.

FIG. 5F shows high level questions pertaining to a patient's advance directives and particularly whether any advance directives exist. As it is an objective of the system to promote that a patient has appropriate advance directives in place, questions asking the patient if they require additional information about advance directives would be asked. The system will also preferably prompt the patient to enter information about their legal advisors. Consent for medical procedures may also be obtained through similar questions.

Other questions at varying levels of detail may be asked around systemic conditions, asthma, blood work, imaging results, etc.

As noted above, the system then flags relevant answers to emergency situations such that the information is available in a logical fashion when an emergency occurs.

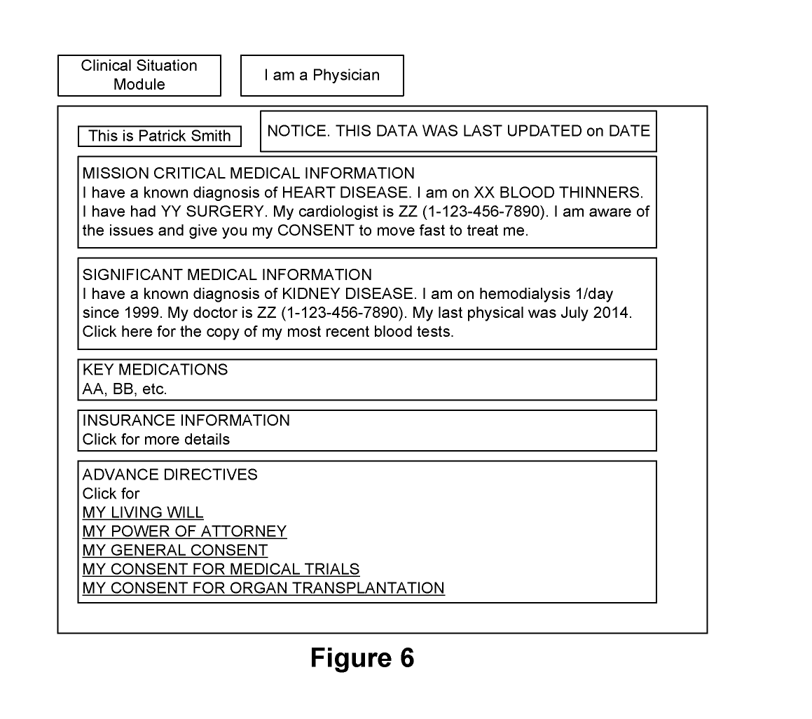

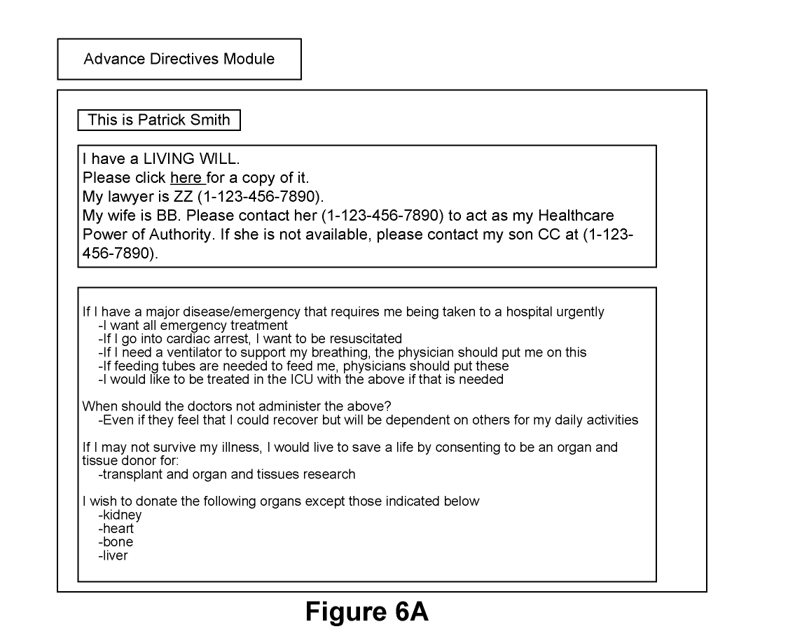

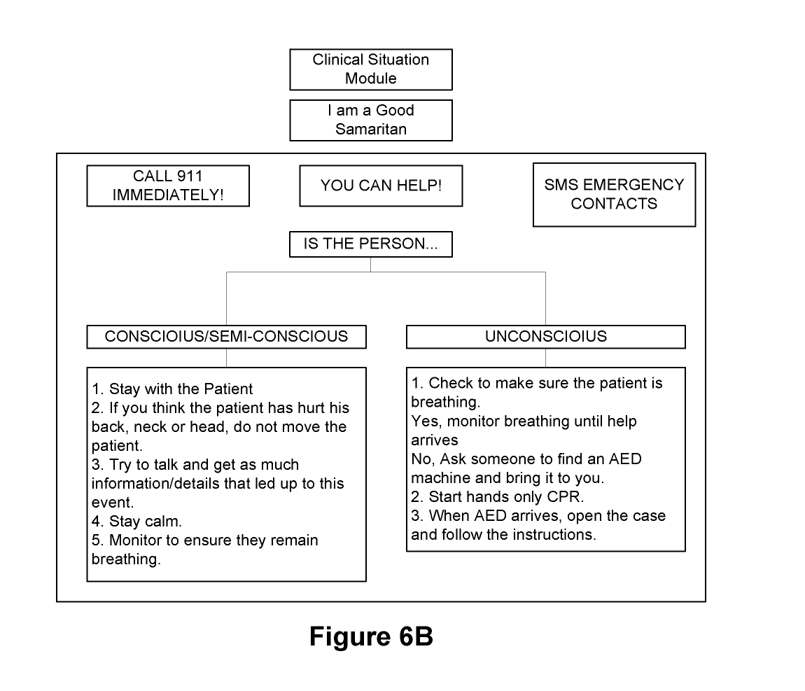

Examples of how information may be presented to a physician and Good Samaritan are shown in FIGS. 6, 6A and 6B. First responders, such as paramedics, may have a different level of information presented to them, but for the purposes of this description are not specifically described herein.

FIG. 6 shows how “mission critical” information may be presented to a physician who has suspected that the patient is experiencing a heart attack. The “mission critical” information is presented higher than the “significant” medical information. Other important information including key medications, the patient's insurance information and links to advance directives may also be presented (FIG. 6A). Importantly, underlying algorithms will determine what is presented. In cases where the patient has no significant history, the only information presented may be insurance and advance directives Information. A statement may also be made that there is no significant history.

In the case of a Good Samaritan (i.e. a non-medial professional) interacting with the system, FIG. 6B shows a representative screen with information show how they can help.

In this regard, other instructions and/or information can be presented to a Good Samaritan or first responder depending on the medical emergency. For example, if the patient is allergic to insect and/or animal bites, instructions regarding the management of anaphylaxis may be presented such as where an epi-pen may be found and how to use it. Other examples may be instructions for moving someone with a possible cervical spine injury, hypoglycemia, CPR, poisoning and other emergencies.

In relation to animal bites, such as insect and snake bites, instructions could be provided advising the patient or others to take a picture of the insect or snake that could then be transmitted to the medical information system and then passed along to the nearest treatment center who could then initiate the preparation of an anti-venom or other appropriate treatment. Other instructions advising of appropriate steps such as tying a tourniquet, inducing vomiting and/or giving fluids may also be presented in a logical format.

Further still, the system may also be set up to provide information to good Samaritans and/or first responders in event of a suicide risk where the system contains information with 1-800 hotlines and/or tips and suggestions for calming a suicidal person down.

FIG. 10 shows a process by which a patient's input may be categorized as important for one or more high level class of emergency. Generally, the question database will have one or more rules associated with that question that depending on the answer will enable data associated with an answer to be mapped to a class of emergency and for a type of responder.

For example Question Q1 within the questionnaire may ask “Have you had a stroke?” Q1 may be answered yes or no (A1). The rules associated with Q1 may be:
If A1 is “No”, goto to Question 2 (where Question 2 is a different class of question); If A1 is “Yes”, goto to Questions 1a-1x; (Questions 1a-1x may obtain Information about data such as [Stroke Severity], [Date of Stroke], [Deficits], [Current Medication], [Current Medication Dosage], [etc.])
   If A1 is “Yes”, Activate Medical Professional (MP) Template 1 and merge answers A1-AX into MP Template 1 (where MP Template 1 includes a standard presentation format applicable to the data)
   If A1 is Yes, Activate Good Samaritan (GS) Template 1 and merge answers A1-AX into GS Template 1.

The MP and GS Templates with merged data are then published to an appropriate location on the output side of the system. For example, as shown in FIG. 10, MP Template 1 is published to both the “Physician-Cardiovascular” and “Physician-Neurological” locations of the output side. The GS Template 1 is published to the “Good-Samaritan-Neurological” location only on the output side.

As such, the information that is relevant to the medical situation is presented based on the information previously obtained from the patient.

### Advance Directive Module

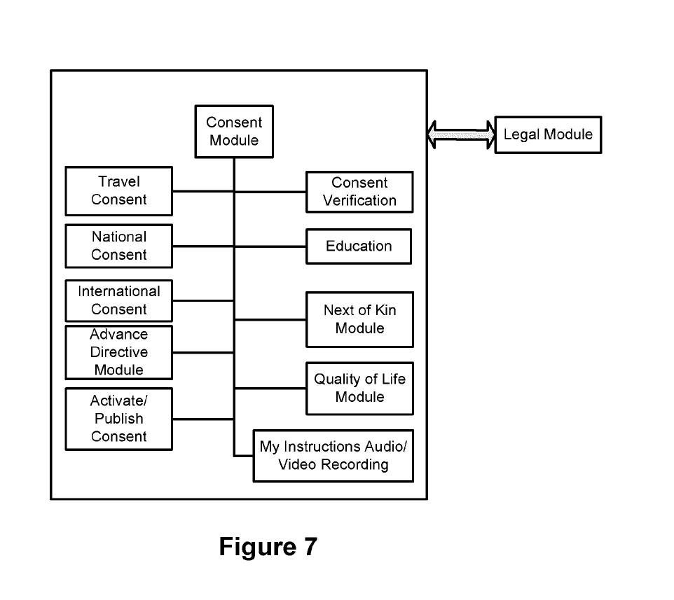

As shown in FIGS. 6A and 7, examples of the physician (FIG. 6A) and patient (FIG. 7) sides of the advance directive module are shown. In greater detail to what is described above, the advance directive module generally manages the advance directives that a patient may be providing under various circumstances. The primary objectives of the advance directive module are for the patient to understand and organize various advance directives that they wish to provide as well as to provide efficient and streamlined notification and authorization to medical practitioners/facilities regarding those directives. Importantly, the advance directive module is structured such that depending on the urgency of the situation, the information that is presented prevents or minimizes delay in diagnosis and treatment. After setting or updating advance directives, a patient may actively publish or make available their instructions.

Advance directives including consent can be multi-leveled and be multi-faceted. Legal and jurisdictional issues are important in providing legally recognized consent and may require specific considerations to be met and/or flexibility in order to implement multi-jurisdictional and legally-legitimate consent. Thus, the advance directive module may also be actively linked to a legal module whose functionality is described below.

The advance directive module, like the medical records is primarily patient-driven in that the patient by accessing the module can tailor the levels of consent/instructions to their specific interests or needs as explained below. Thereafter, the advance directive module is accessible by medical practitioners/facilities/families (being subject to set levels of security if desired) such that the information is readily available to those medical practitioners/facilities/families when needed.

In one embodiment, the patient may also include voice and/or video recordings as a component of their advance directives that are accessible through the system. For example, a patient may provide a recording that clearly provides an indication of their consent/wishes that can be reviewed by physicians and family members. In this embodiment, a patient may attend at a lawyer's office and provide instructions through an interview with their lawyer and/or they may provide a less formal type of instruction through a recording is directed more to family members/loved ones. Such recordings may be highly effective in assisting family members/loved ones in understanding what the patient's wishes might be. When a recording is made, the recording can be uploaded to the MIS.

In a further embodiment, the advance directive module may be utilized for a patient to provide their consent to a specific research trial. For example, the system may notify the patient through a news service of a particular research trial that may be occurring in their jurisdiction or elsewhere. If the patient wishes, the system may enable the patient to provide their consent to participate in the trial if and when conditions are such that they could participate. Typically, this consent would be provided for those trials assessing treatments in an emergency or acute situation where a patient may not otherwise be able to provide consent.

### Educational Module

The process of providing consent/advance directives may also be integrated with an education module that provides a patient with an informed basis on which to design various advance directives including powers of attorney, living wills, physician orders for life-sustaining treatment (POLST), organ transplantation wishes and others. Further, the combination of an advance directive module and education module can provide an effective means of educating and involving family members, next-of-kin and/or guardians with respect to the wishes of a patient with regards to their medical treatment. Access to the advance directive and education modules may be granted to specific family members if desired as shown in FIG. 2.

It is important to note that the efficiency by which a patient's wishes are presented can have a significant impact on the decision making process regarding treatment. From an economic perspective, the efficiency by which advance directives are made known to a physician/treatment facility can have enormous impacts on the costs of health care. Very often, within the current medical system, a patient's wishes are not known, due to poor communication between any one of or a combination of the patient, their family/loved ones, lawyers and physicians with the result being highly expensive treatments are given to patients to prolong life against the wishes of the patient. With an aging population, and spiraling health care costs (where 90% of health care costs are incurred in the last 10% of one's life), improving the efficiency of advance directives through communication will have an enormous effect on the overall costs of health care.

For the purposes of illustrating the operation of the advance directive module, a representative description of an older patient in relatively good health who wishes to interact with the advance directive module to provide their consent for potential future medical situations is provided. After accessing the system, the patient wishes to design an advance directive such that in the event of certain medical situations, the appropriate decisions can be made by medical practitioners and family members regarding care. At a first level, the patient wants to ensure that in the event of an acute emergency where they are not in a position to provide their verbal or written consent that the attending health care provider can easily access and understand the patient's consent. For example, in a situation where the patient has suffered an acute stroke or myocardial infarction, the patient's instructions may wish that the medical team takes all necessary steps to ensure survival. This information may be presented as shown in FIG. 6A to the physicians.

However, the patient's instructions may be conditioned on the likely outcome of treatment. That is, the patient's instructions may be to limit treatment if the outcome of treatment is likely to result in an undesirable quality of life as set forth in a living will.

In this regard, the patient may have reviewed the education material components of the education module to learn about what the implications of surviving a severe stroke may be regarding quality of life. That is, the education module may include information about the reality of life under certain conditions including one or more of combinations of the inability to speak, the inability to walk or move and/or the loss of vision at one end of the spectrum. The education module will also include material and/or information regarding quality of life when the stroke is relatively minor.

In either event whether or not the patient has reviewed educational material, based on the desired wishes of the patient, the advance directive module enables the patient to design and implement an advance directive that identifies the qualitative thresholds for treatment. In addition, the MIS may provide access to lawyers through a legal module that can assist in ensuring that the advance directives that are created are legally sufficient. This may involve separate steps of meeting with a lawyer to ensure that legal documents are witnessed and/or notarized as may be required. In various embodiments, the legal module may simply provide a list of local lawyers, or may provide a list of approved lawyers and/or may enable a patient to contact a lawyer who may be working within a call center or be associated with one.

Further still, the MIS, through the legal, education and/or advance directives module provide instructions on how to create an audio and/or video recording of a patient's wishes.

When implemented through the system, at the crucial time, when decisions need to be made regarding treatment, accessing the system through the patient's devices or a website by medical practitioners and/or family members enables the patient's living will instructions to be carried out. As noted above, the economic impact of only providing treatment when it is wanted is significant.

In addition, within the consent module, additional functionality may be implemented to enable the patient to “customize” their consent for anticipated scenarios. For example, if a patient anticipates travel to a particular destination, the patient may enter their travel destinations and dates into the consent module. The system, based on the information entered and the current status of the patient's consent, will review and determine if consent needs to be created or updated based on that information. In reviewing the consent, the system may review the status of consent as being not-existent, current or expired and provide appropriate prompts to enable the patient to create and/or update their consent.

In one scenario, if travel is listed as within a home jurisdiction (e.g. provincial or state), then the system may determine that all consents are current and no updating is required (FIG. 7).

If travel is outside a home jurisdiction (e.g. nationally), the system may determine that a particular consent should be updated. For example, in some jurisdictions, consent for certain procedures may only be valid for a limited time period in which case a consent may need to be updated.

If travel is international, additional considerations may be relevant. For example, travel to a country with a different language could trigger the translation of generic or specific consents to those languages. This may be done automatically in the case of generic consents that the system has previously translated or may require the translation of a specific document by a human translator. Machine translations may be acceptable in some circumstances.

Importantly, the system will grow a library of consent precedents that may be required or usable within a particular jurisdiction that the patient will have access to. Thus, over time, the efficiency and uniformity of the system will improve as the knowledge database is grown.

As noted above, the system may also include a legal access module where the patient can interact with live legal personnel to provide assistance. This may also involve involvement of the patient's independent legal counsel.

Importantly, the advance directive module will also enable a patient to authorize a treating physician/practitioner who may be providing acute care in one jurisdiction to communicate with other physicians who may have direct knowledge of the patient's history in another jurisdiction. That is, in the event that an emergency physician is treating an acute stroke in a distant ER, the system can be utilized to provide the contact information and approval for that ER physician to call another physician directly.

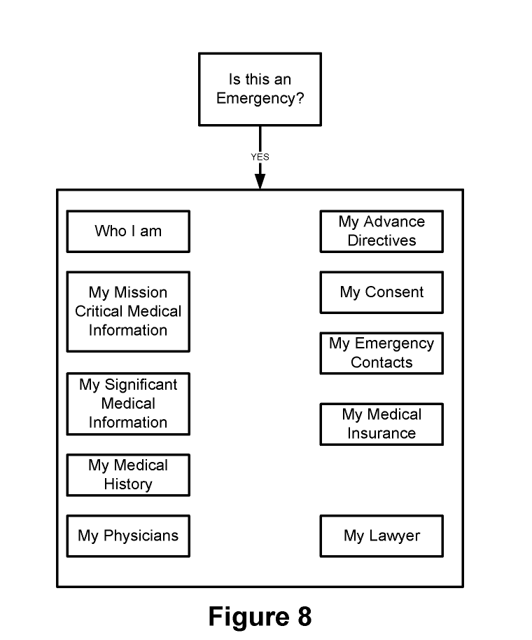

Preferably, when a treating physician/professional/hospital is reviewing a patient's consents from the system, the system will recognize that the access is being initiated by medical practitioners/hospitals such that the information is presented to those people in an initial screen. For example, the system will recognize that information about the patient, who lives in Alberta, is being sought by a medical practitioner/hospital in New York City and may therefore be an emergency. In this case, the system may immediately prompt the medical practitioner/hospital “Is this access an Emergency?”. If the answer is yes, the system may immediately display specific prompts to links such as “For ‘Patient Name’ Medical History Information, Click Here” and “For ‘Patient Name’ General and Specific Consent, Click Here” and “For ‘Patient Name’ Advance Directive Instructions, Click Here”. FIG. 8 is a further representative display where instructions/information is displayed.

Thus, the accessing personnel can quickly and effectively obtain relevant information depending on what information is immediately required. Other prompts or graphical information may be displayed depending on how the patient may have configured their profile. In one case, important information may be flashed or immediately displayed such as the patient being diabetic, being on blood thinners or other medication that could have an immediate impact on what a treatment decision may be. In other cases, key criteria of a living will may be flashed. Further still, in the event that additional detail and/or support are needed, the accessing personnel may drill down through any supporting documentation. The system will also be set up such that information desired by the accessing personnel can be either immediately downloaded or printed as desired.

### System Access and Identification

As discussed above, current standards for medical records and consent generally require onerous procedures by all personnel accessing such information to ensure that patient confidentiality is maintained with the result being that significant time and resources are wasted at many levels simply identifying and verifying a person. As discussed, a primary objective of the system is to simplify, streamline and/or enable a patient to waive such confidentiality.

In various embodiments of the system, different processes may be implemented in order to grant access to patient information. At one level, if desired by the patient, the patient may set no security such that their medical records are fully available over the internet. Internet verification may be done by standard available pieces of information such as name, date of birth, address, driving license number etc.

Older patients and/or those people, who have no concerns about the contents of their medical, consent and/or living will records may choose this option. In other embodiments, various levels of security may be implemented that may include different forms of user IDs and passwords. In addition, various forms of hardware such as smart phones, smart cards, magnetic swipe codes etc. may be used as a conduit for communicating a patient's identification information.

Other forms may include bracelets showing toll-free numbers that may require one or more codes and/or challenge questions to be answered.

### Biometric Identification

In one embodiment, the identity of a patient using the system is confirmed by a biometric identifier such as a fingerprint, retinal scan or other technique. In this embodiment, either at the medical record stage or consent or emergency stages of the system, the identity of a patient can be quickly and effectively used to gain access to medical or consent information from the system database.

For example, at one level, if an unconscious patient is being transported in an ambulance and the first responders recognize that the patient is a system user by various means such as a bracelet, audio and/or visual indicator, the first responder can obtain a fingerprint scan from the patient that will automatically link the first responders to the patient's identity, medical records and consent information. In this case, the first responders may be carrying specialized scanners that enable the fingerprint information to be transmitted over a cellular or satellite network. Alternatively, a patient's smart phone could be used.

Gaining access through a biometric identifier may automatically trigger various response actions based on the means by which and/or the location the request is being made from. These may include a call back to a cell phone by system call center staff to clarify/confirm the situation, one or more computer system prompts (as discussed above) to analyze the situation and/or the automatic opening of medical records at the treatment facility where the patient is being transported to.

At another level, in seeking approval for the transfer of medical records by the patient, the system may utilize a protocol that initially confirms the situation is not an emergency. Once the situation is confirmed as not being an emergency and the patient interaction is of a profile updating measure, the system may utilize protocols that confirm patient's instructions to third parties. For example, the system may automatically send an automatically generated letter to a physician/treatment facility to transfer a medical record. In this case the physician/treatment facility could require approval for the transfer from the patient. In one embodiment, this could take the form of a text to the patient's smart phone requiring a biometric signature to be returned as confirmation of the request.

In each case, additional confirmation codes may be included if deemed necessary. For example, the system may not simply accept a scanned fingerprint from a patient as sufficient to open their medical records and consent records, and may require that the identity of the first responder/physician be included and matched within a database of authorized first responders/physicians. Similarly, authorized equipment having embedded device codes may be required.

In each case, depending on patient settings, the patient may waive these security levels such that a simple scan is sufficient to open their records.

Importantly, the biometric system may also be used to initiate an emergency call system by a patient. For example, a patient suffering from an acute stroke or myocardial infarction may be able to biometrically activate the system to summon help and otherwise initiate procedures at a treatment facility.

### Recent Medical Advances Module

In a further embodiment, the system includes a Recent Medical Advances Module that enables users to stay abreast of medical issues that may be pertinent to there own situation. For example, in the treatment of acute stroke, as discussed in co-pending international patent application based on U.S. provisional application 61/697,282 advances in techniques for the diagnosis of hemorrhagic and ischemic stroke are improving the time between onset and treatment which has a positive improvement on patient outcome. Thus, as an example, this type of information can be summarized and forwarded to a patient if and when they indicate they are interested in receiving such information. The availability of this information may be beneficial to patient in making a decision regarding whether treatment is to be authorized. That is, if the patient understands that current best practices are improving to improve diagnosis and treatment times, this may influence a decision.

### Call Center

The system may include a 24/7 call center that enables the patient to interact with assisting personnel on medical records, consent, and/or legal issues. Similarly, the call center may be available to assist medical practitioners in communications with other medical practitioners, hospitals or family.

### Insurance Module

In one embodiment, the system includes an insurance module that has one or more active links to an insurer's database that may provide various information back to the treating physician/facility including that the patient has insurance, the insurance policy number, and/or the authorization to proceed under their instructions/authority. The linking of the insurance information may also be driven by the patient from within the PAM. Similarly, a patient's banking and/or financial advisor contact information may be linked for the purposes of the patient authorizing payments for treatment.

### Family Member Communication

In one embodiment, the system may also be used as a means of enabling family members to communicate with one another about a patient. For example, if a number of siblings are caring for an aged parent (together with one or more physicians), if some or all of the siblings/physicians have been granted access to the system, the system may enable inter family-member/physician communication for the purposes of providing that care.

For example, a physician may be aware that two siblings are sharing the care-load of a parent. The physician may use the system to upload recent information (e.g. about a treatment) which then automatically advises the siblings of that information. The siblings may then communicate with each other through the system to discuss next steps.

### Geographical Linking

In other embodiments, the medical information system (MIS) enables a number of geographical linking features. In these embodiments, the database includes relevant information about medical facilities and/or medical equipment including the location of such facilities and/or equipment. In addition to location, additional data may be included such as the capabilities of a medical facility (e.g. it has an emergency department; it is a limited emergency department; it cannot handle certain emergencies), or the type of medical equipment that may be located at a particular location.

For example, in the event that a patient is experiencing an emergency, and a good Samaritan has accessed the system through a user's mobile device (having location functionality) and identifies that the patient may be having a heart attack, that information together with the geographical location of the mobile device can be reported to the MIS. Upon receipt of both the nature of the emergency and the location of the mobile device, the MIS can determine the closest medical facility that is capable of treating a patient having a heart attack, ordering those facilities in terms of nearest proximity and instructing the mobile device to provide route information to be displayed on the device. In addition, the MIS can search its database and notify the device of nearby medical equipment (such as a defibrillator, first aid kit, poison treatment kit, etc.) that may be close to the patient again providing information that may assist a responder to locate and use such a device.

### Mobile Devices

In the context of this description mobile devices generally include “smart” devices, (e.g. Apple Corporation's Iphone™, Ipad™, Iwatch™ and various laptop and desktop products; Samsung Corporation's Android™ phones, tablets and laptop products) that have know current functionality including various communications functionality such as cellular, wifi, and/or GPS functionality as well as various user interface functionalities such as touch-screen functionality.

New technologies such as Apple Corporation's Iwatch™ and other “wearable” technology contemplate interfacing various sensors to such devices having functionality to monitor body activities including pulse rate, body temperature, and body movement. Other sensors may be configured to a patient that communicate to a wearable technology or a smart phone via Bluetooth or other links.

Accordingly, in various embodiments of the invention, such technology can be integrated to the MIS such that various body parameters and/or combinations of body parameters trigger events that are reported to the MIS. For example, a drop in pulse rate, outside a previously determined normal range for a patient, may trigger MIS reporting. MIS reporting could trigger call center intervention in the form of a call to the patient as well as the automatic display of relevant patient information to the call center who may then be able to ask relevant questions to the patient and/or emergency procedures such as dispatching an ambulance. As such, the call center may be able to intervene and/or participate in determining an appropriate course of action. Such functionality may also be incorporated in the event that a second party (including a Good Samaritan, paramedic and/or physician) is involved as well where the second party can use the patient's mobile device to talk to call center personnel.

Further still, body sensors may also be used to activate audio and/or visual identifiers on the mobile device alerting nearby people that a medical emergency may be occurring with instructions regarding how to react. For example, if a combination of parameters triggers recognition of a possible emergency, the patient's mobile device can then initiate an alert in the form a flashing screen, an audible buzzer and/or audio instructions on how to react. Audio instructions may include text along the lines of “I may be in medical distress. Please press the Emergency Button that is flashing on my iphone.” When the second party follows these instructions, additional instructions may be given as appropriate.

In various embodiments, a patient's mobile device will generally have functionality that enables a second party to bypass a mobile device's security features such as a password protection screen (or other security features) to gain access to the MIS and related systems.

Although the present invention has been described and illustrated with respect to preferred embodiments and preferred uses thereof, it is not to be so limited since modifications and changes can be made therein which are within the full, intended scope of the invention as understood by those skilled in the art. Moreover, terms used within this application such as living will, power of attorney, general consent, specific consent, consent for organ transplantation are understood to mean legal documents that have particular meanings within the legal systems of different jurisdictions. Generalized medical terms such as cardiac, neurological, blood, chronic condition, acute condition, current medications, recent surgeries, images, etc. are used as a means to provide categorization for various types of medical data. It is understood that such terms are used a means of organizing types of medical data and that in various scenarios, there may be overlap between categories and the data such categories may contain. As such, the these terms are not intended to rigidly limit how data may be categorized but rather is intended to provide a high level overview regarding organization as would be understood by those skilled in the art.

1. A method of obtaining medical data about a patient from a first party, the first party including any one of or a combination of the patient and one or more other persons, and presenting specific medical data pertaining to one or more medical conditions about the patient to another party, the method of obtaining and presenting occurring through a computer network, the method comprising the steps of:
a) enabling the first party to access an input system, the input system enabled to enroll a patient within a medical information system operably connected to the computer network;
b) enabling the first party to input medical data about the patient into the medical information system, where the first party provides an answer to individual questions of a pre-set series of questions displayed to the first party and wherein at least one individual question has a pre-set selection of answers associated with each individual question;
c) applying at least one pre-set rule to each individual question, wherein a pre-set rule will flag the answer to an individual question as being relevant or not-relevant to one or more of a set number of medical conditions to a create flagged answer,
d) placing a flagged answer marked as relevant within a document template associated with a specific medical condition;
e) on a computer device operatively linked to the medical information system, displaying access information describing at least one of the set number of medical conditions;
f) displaying a document template on the computer device, the document template having at least one flagged answer marked as relevant displayed therein and wherein the document template is associated with a specific medical condition and is displayed when access is gained via step e).

2. A method as in claim 1 wherein the set number of medical conditions displayed on the computer device are identified as relating to any one of or a combination of “Stroke”, “Heart Attack”, “Anaphylaxis”, “Trauma”, “Asthma”, “Seizure”, “Insulin”, “Unconscious”, “Poisoning”, “Animal Bite” and “Insect Bite”.

3. A method as in claim 1 further comprising the steps of b1) enabling the first party to input advance directive data from the patient into the medical information system into a patient record within the medical information system and e1) on a computer device operatively linked to the medical information system, displaying access information to the advance directive data from the patient within the patient record and f1) displaying the advance directive data from the patient when access is gained through step e1).

4. A method as in claim 3 wherein the advance directive data includes any one of or a combination of audio or video data.

5. A method as in claim 3 where the advance directive data includes any one of or a combination of a living will, a power of attorney, general consent, specific consent, consent for medical trials and consent for organ transplantation.

6. A method as in claim 1 wherein the individual questions of a pre-set series of questions comprise a questionnaire and wherein the questionnaire includes groups of individual questions relating to a category of medical data that are presented to the first party sequentially in accordance with a pre-set order, the method further comprising the step of when an answer to a question is marked as not-relevant, additional questions within a group are not displayed and a first question within another group is displayed.

7. A The method as in claim 1 where step b) includes enabling the first party to input advance directive data relating to a patient into the medical information system where the first party provides an answer to individual questions of a pre-set series of questions displayed to the first party and wherein at least one individual question has a pre-set selection of answers associated with each individual question.

8. A method as in claim 1 where the another party is identified as any one of or a combination of a Good Samaritan and medical professional.

9. (canceled)

10. A method as in claim 1 further comprising the step of b2) enabling the first party to input medical data about the patient into pre-set medical categories.

11. A method as in claim 1 where the pre-set medical categories include any one of or a combination of Blood, Cardiac, Neurological, Surgeries, Images, Medications, Treatments, Acute Conditions, Chronic Conditions.

12. A method as in claim 1 further comprising the step of b3) wherein a pre-set rule includes applying a weighting factor to a flagged answer marked as relevant to determine the relative importance of a flagged answer and f2) displaying a document template containing data having a weighting factor above a pre-determined threshold in a prominent position when access is gained through step e).

13. A method as in claim 12 further comprising the step of b4) applying one or more additional pre-set rules to one or more flagged answers marked as relevant and based on those additional pre-set rules applying additional weighting factors to prioritize the display of particular data through the at least one computer device.

14. A method as in claim 12 further comprising the step of displaying prioritized data in distinct categories, where each category has a threshold for display of prioritized data in a specific category based on the pre-set rules.

15. A method as in claim 1 where the pre-set series of questions displayed to the first party include questions relating to any one of or a combination of contraindications to magnetic resonance imaging, questions relating to past surgeries of the patient, questions relating to active insurance information of the patient, questions relating to providing instructions to a Good Samaritan.

16-18. (canceled)

19. A method as in claim 1 further comprising the step of limiting access to the medical information system through the computing device and wherein the step of limiting access requires biometric information from the patient to be entered prior to gaining access through the computing device.

20. A method as in claim 19 wherein the biometric information includes any one of or a combination of a fingerprint scan, retinal scan, facial recognition, hand geometry, and vein pattern recognition.

21. A method as in claim 1 further comprising the step of when a first responder or a physician has activated the system, the first responder or physician further identifies themselves to the system and a medical facility associated with the first responder or physician is given access to a patient's medical information within the medical information system when the first responder or physician is recognized as being previously enrolled with the system.

22. A method as in claim 1 further comprising the steps of associating a date with a flagged answer marked as relevant, monitoring the age of a flagged answer marked as relevant and applying a further pre-set rule associated with the flagged answer marked as relevant, and forwarding an electronic notice to the first party if a pre-determined time period has elapsed, the electronic notice advising the first party of an age of the flagged answer marked as relevant.

23. A method as in claim 1 further comprising the steps of:
a) enabling a first party to enter travel data into the medical information system including a departure date, at least one travel destination and at least one return date;
b) comparing the at least one travel destination to a database containing advance directive requirements for a jurisdiction to determine advance directive requirements for the patient for the at least one travel destination;
c) comparing advance directive requirements for the at least one travel destination against a suitability of existing advance directives within the medical information system for a patient wherein any advance directives within the medical information have been previously flagged as suitable or not-suitable for a jurisdiction;
d) initiating communication with the first party to inform the first party if existing advance directives are suitable or not-suitable for the at least one travel destination.

24. A method as in claim 1 further comprising the steps of:
a) enabling a first party to register a patient's mobile device having location determination functionality with the medical information system and associating the mobile device with the patient within the medical information system;
b) when the mobile device is accessed and activated during an emergency, reporting the location of the mobile device to the medical information system.

25. A method as in claim 24 further comprising the steps of: when the location of the mobile device is reported to the medical information system, the medical information system searches a database of medical facilities, determines a list of medical facilities closest to the mobile device and provides instructions to the mobile device to display a list of medical facilities in order of proximity to the mobile device.

26. A method as in claim 25 further comprising the steps of: activating map and route software on the mobile device to display a route to at least one of the closest medical facilities.

27. A method as in claim 26 where the medical information system compares the type of medical emergency that is occurring with the patient against the database of medical facilities wherein the database of medical facilities includes information about the capabilities of a medical facility to treat specific medical conditions, and the medical information system determines the closest medical facility capable of treating the patient for an identified emergency medical situation.

28. A method as in claim 20 further comprising the steps of: when the location of the mobile device is reported to the medical information system, the medical information system searches a database of medical equipment, determines a list of medical equipment closest to the mobile device and relevant to an identified emergency medical situation, and provides instructions to the mobile device to display a list of medical equipment in order of proximity to the mobile device.

29. A method as in claim 28 further comprising the steps of: activating map and route software on the mobile device to display a route to at least one of the closest medical devices.

30. A method as in claim 28 wherein the medical equipment includes any one of or a combination of a defibrillator kit, a first aid kit, an anti-poisoning kit, and an angina treatment kit.

31. A method of obtaining advance directive data about a patient from a first party, the first party including any one of or a combination of the patient and one or more other persons, and presenting advance directive data about the patient to another party, the method of obtaining and presenting occurring through a computer network, the method comprising the steps of:
a) enabling the first party to access an input system, the input system enabled to enroll a patient within a medical information system operably connected to the computer network;
b) enabling the first party to input advance directive data about the patient into the medical information system where the advance directive data is an electronic advance directive file containing information for any one of or a combination of a patient's living will, power of attorney, general consent, specific consent, consent for medical trials, and consent for organ transplantation;
c) placing the electronic advance directive file within a patient record within the medical information system; and,
d) on a computer device operatively linked to the medical information system, displaying access information enabling another party to access each of the patient's electronic advance directive files within the patient record.

32. A method as in claim 31 where the electronic advance directive file is any one of or a combination of a text, audio and video file.

33. A system for obtaining medical data about a patient from a first party, the first party including any one of or a combination of the patient and one or more other persons, and presenting specific medical data pertaining to one or more medical conditions about the patient to another party, the system comprising:
a computer database operatively connected to a computer network, the computer database having an input system enabling the first party to enroll a patient within a medical information system (MIS) through a local or remote computer interface;
the computer database further having a medical data module enabling the first party to input medical data about the patient into the medical information system, where the medical data module enables the first party to provide an answer to individual questions of a pre-set series of questions displayed to the first party and wherein at least one individual question has a pre-set selection of answers associated with each individual question;
the medical data module further applying at least one pre-set rule to each individual question, wherein a pre-set rule will flag the answer to an individual question as being relevant or not-relevant to one or more of a set number of medical conditions to a create flagged answer and placing a flagged answer marked as relevant within a document template associated with a specific medical condition;
at least one computer device having hardware and software enabling:
a) the at least one computer device to operatively connect to the medical information system;
b) displaying access information describing at least one of the set number of medical conditions and enabling access through an access information display;
c) displaying a document template having at least one flagged answer marked as relevant wherein the document template is associated with a specific medical condition and is displayed when access is gained through the access information display.

34. A system as in claim 33 wherein the set number of medical conditions displayed on the computer device are identified as relating to any one of or a combination of “Stroke”, “Heart Attack”, “Anaphylaxis”, “Trauma”, “Asthma”, “Seizure”, “Insulin”, “Unconscious”, “Poisoning”, “Animal Bite” and “Insect Bite”.

35. A system as in claim 33 wherein the medical data module further enables the first party to input advance directive data from the patient into the medical information system into a patient record within the medical information system and on a computer device operatively linked to the medical information system is enabled to display access information to the advance directive data from the patient within the patient record and to display the advance directive data from the patient when access is gained through the access information display.

36. A system as in claim 35 wherein the advance directive data includes any one of or a combination of text, audio or video data.

37. A system as in claim 29 where the advance directive data includes any one of or a combination of a living will, a power of attorney, general consent, specific consent, consent for medical trials and consent for organ transplantation.

38. A system as in claim 33 wherein, within the medical data module, the individual questions of a pre-set series of questions comprise a questionnaire and wherein the questionnaire includes groups of individual questions relating to a category of medical data that are presented to the first party sequentially in accordance with a pre-set order, and wherein the medical data module, when an answer to a question is marked as not-relevant, additional questions within a group are not displayed and a first question within another group is displayed.

39. A system as in claim 33 where the medical data module enables the first party to input advance directive data relating to a patient into the medical information system where the first party provides an answer to individual questions of a pre-set series of questions displayed to the first party and wherein at least one individual question has a pre-set selection of answers associated with each individual question.

40. A system as in claim 33 where the another party is identified as any one of or a combination of a Good Samaritan and medical professional on the at least one computer device.

41. A system as in claim 40 where a medical professional is separately identified as a physician and a first responder.

42. A system as in claim 33 wherein the medical data module enables the first party to input medical data about the patient into pre-set medical categories.

43. A system as in claim 42 where the pre-set medical categories include any one of or a combination of blood, cardiac, neurological, surgeries, images, medications, treatments, acute conditions, and chronic conditions.

44. A system as in claim 33 where the medical data module applies one or more additional pre-set rules to one or more flagged answers marked as relevant and based on those rules applies an additional weighting factor to prioritize the display of particular data through the at least one computer device.

45. A system as in claim 33 where within the medical data module, the pre-set series of questions displayed to the first party include any one of or a combination of questions relating to contraindications to magnetic resonance imaging, questions relating to past surgeries of the patient, questions relating to active insurance information of the patient, and questions relating to providing instructions to a Good Samaritan.

46-48. (canceled)

49. A system as in claim 33 wherein the at least one computer device includes a biometric access device operatively connected to the at least one computer device and the at least one computer device enables access to the medical information system through the computing device when pre-set biometric information from the patient is entered into the at least one computing device.

50. A system as in claim 33 wherein the system includes means for, when a first responder has activated the system, the system enables a first responder to identify themselves to the system and a medical facility associated with the first responder is given access to a patient's medical information within the medical information system.

51. A system as in claim 33 wherein the medical data module further enables associating a date with a flagged answer marked as relevant, monitoring the age of a flagged answer marked as relevant, applying a further pre-set rule associated with the flagged answer marked as relevant, and forwarding an electronic notice to the first party if a pre-determined time period has elapsed wherein the electronic notice advises the first party of an age of the flagged answer marked as relevant.
